(19) United States
(12) Patent Application Publication
(10) Pub. No.: US 2015/0363862 A1
(43) Pub. Date: Dec. 17, 2015

(54) FINANCIAL PRODUCT RECOMMENDATION FOR A CONSUMER

(71) Applicant: Connect Financial LLC, Wellesley, MA (US)

(72) Inventors: Joseph Ranft, Brookline, MA (US); Sean Collins, Wellesley, MA (US)

(21) Appl. No.: 14/304,633

(22) Filed: Jun. 13, 2014

(51) Int. Cl. G06Q 30/06

(52) U.S. Cl. CPC G06Q 30/0631

(57) ABSTRACT

A computer-implemented method comprising: comparing, by one or more computer systems, personal profile information of a consumer to financial product information for financial products; identifying, based on the comparing, one of the financial products with a higher relevance to the consumer relative to relevances of others of the financial products; and generating, based on the identified financial product, a financial product recommendation specifically for the consumer.

### BACKGROUND

A financial product includes a good or a service connected with a way in which an individual manages and uses money. There are various types of financial products, including, e.g., bank accounts, investment accounts, credit cards, insurance policies, mortgages, and so forth.

### SUMMARY

In an example, a computer-implemented method includes comparing, by one or more computer systems, personal profile information of a consumer to financial product information for financial products; identifying, based on the comparing, one of the financial products with a higher relevance to the consumer relative to relevances of others of the financial products; and generating, based on the identified financial product, a financial product recommendation specifically for the consumer. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The actions include generating a score for the identified financial product, the score being indicative of an assessed valuation of the financial product, and the score being based on evaluation of the identified financial product across a plurality of variables. The actions include retrieving information indicative of scores that are assigned to the plurality of variables; wherein generating the score comprises: generating the score based on the assigned scores. The actions include generating information for a graphical user interface that when presented on a client device displays: a first graphical representation of the financial product recommendation specifically for the consumer; and a second graphical representation of the score for the identified financial product that is included in financial product recommendation specifically for the consumer; wherein the first graphical representation is juxtaposed to the second graphical representation in the graphical user interface. The personal profile information comprises information indicative of one or more preferences of the consumer, and wherein the financial product information comprises information indicative of attributes of the financial products, and wherein the method further comprises: determining a match between at least one of the one or more preferences and an attribute of one of the financial products; and assigning the one of the financial products to a group of candidate financial products that are candidates for recommendation to the consumer.

The actions include applying a filter to attributes of the candidate financial products in the group, with the filter specifying one or more requirements for a financial product to be recommended to the consumer; and removing, based on application of the filter, a candidate financial product from the group, with at least one of the one or more requirements being unsatisfied by an attribute of the removed candidate financial product; wherein identifying the financial product with the greater relevance to the consumer comprises: identifying, from the remaining candidate financial products in the group, a candidate financial product with a greater relevance to the consumer, relative to relevances of others of the candidate financial products. The candidate financial product with the increased amount of relevance to the consumer is a particular financial product, among the remaining candidate financial products, with a highest amount of matches between attributes of the particular financial product and the one or more preferences of the consumer.

The one or more preferences of the consumer comprise a pricing preference for a financial product, wherein an attribute comprises a price, and wherein the filter comprises a personalized pricing filter that eliminates products based on the pricing preference of the consumer, and wherein the method further comprises: determining a mismatch between the pricing preference and a price of the candidate financial product that is removed. The actions include receiving, from a client device associated with the consumer, a request for an application for the identified financial product, with the identified financial product being included in the financial product recommendation specifically for the consumer; causing information indicative of the requested application to be transmitted to the client device; receiving, from the client device, a completed version of the requested application; granting access to the completed version of the requested application to a financial service provider that provides a financial product that is applied for by the application; and notifying the financial service provider that the completed version of the requested application is available for review. The actions include pre-populating, based on contents of the personal profile information, one or more fields of the requested application; wherein causing the information indicative the requested application to be transmitted to the client device comprises: transmitting to the client device information indicative of the requested application with the one or more pre-populated fields.

The actions include receiving information specifying that the financial service provider approves the application for the financial product of the financial service provider; transmitting, to the client device, information indicative of the approval; and receiving, from the client device, instructions to update the personal profile information of the consumer with product detail information for the financial product for which the application is approved. The actions include receiving, from a client device associated with the consumer, a request for an application for the identified financial product, with the identified financial product being included in the financial product recommendation specifically for the consumer; causing information indicative of the requested application to be transmitted to the client device; receiving, from the client device, a completed version of the requested application; granting access to the completed version of the requested application to a financial service provider that provides a financial product that is applied for by the application; and notifying the financial service provider that the completed version of the requested application is available for review.

The actions include receiving, from a client device associated with the consumer, a request for a price quotation for one or more financial products; causing processing of the request for the price quotation by multiple providers; and transmitting, to the client device, information indicative of multiple price quotes for financial products of the multiple providers. Causing the processing comprises: transmitting to the multiple providers anonymous information that is indicative of a request for a price quote, with the anonymous information not including identifying information of the consumer, and with the anonymous information including other types of information that promote generation of the price quote.

The actions include in response to the request, providing single-source application anonymous processing for multiple providers by: accessing, from a data repository, personal profile information of the consumer; generating anonymous consumer information by removing, from the personal profile information, identifying information of the consumer; and transmitting to the providers the anonymous information for application processing. The actions include generating information for a web-accessible provider portal that when presented on a client device displays: a plurality of controls for a financial product service provider to view an application for a financial product, provide a quote for the financial product, and approve the application for the financial product. The actions include analyzing consumer information stored in a customer profile database; identifying, based on analyzing, common characteristics of consumers; identifying, based on the common characteristics, a common product need of the consumers; and generating a custom financial product for the consumers that address the common product need.

In another example, a computer-implemented method includes retrieving information indicative of one or more financial products and providers; applying one or more curation policies to the retrieved information, wherein a curation policy includes a criteria for a financial product or provider to satisfy for inclusion of a group of financial products to be scored; filtering, based on applying the one or more curation policies, the financial products to a subset, with financial products in the subset satisfying criteria specified by the one or more curation policies. One or more machine-readable hardware storage devices storing instructions that are executable by one or more processing devices to perform operations comprising: comparing personal profile information of a consumer to financial product information for financial products; identifying, based on the comparing, one of the financial products with a higher relevance to the consumer relative to relevances of others of the financial products; and generating, based on the identified financial product, a financial product recommendation specifically for the consumer. Other embodiments of this aspect include corresponding computer systems, apparatus, and computer programs recorded on one or more computer storage devices, each configured to perform the actions of the methods.

All or part of the foregoing may be implemented as a computer program product including instructions that are stored on one or more machine-readable hardware storage devices (and/or one or more non-transitory machine-readable media), and that are executable on one or more processing devices. All or part of the foregoing may be implemented as an apparatus, method, or electronic system that may include one or more processing devices and memory to store executable instructions to implement the stated operations.

The details of one or more embodiments are set forth in the accompanying drawings and the description below. Other features, objects, and implementations will be apparent from the description and drawings, and from the claims.

### DESCRIPTION OF DRAWINGS

FIGS. 1A-12 are diagrams of environments for providing users with financial product information.

FIGS. 13-28 are diagrams of graphical user interfaces for providing users with financial product information.

FIG. 29 is a block diagram of a system for analyzing financial products.

FIG. 30 is a block diagram of components of a system for analyzing financial products.

FIGS. 31-35 are flow charts of processes executed by a system for analyzing financial products.

Like reference symbols in the various drawings indicate like elements.

### DETAILED DESCRIPTION

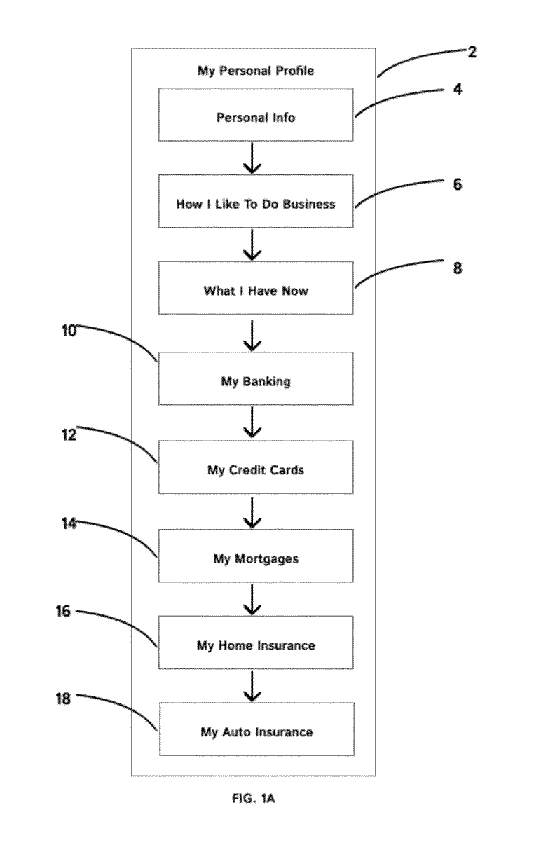

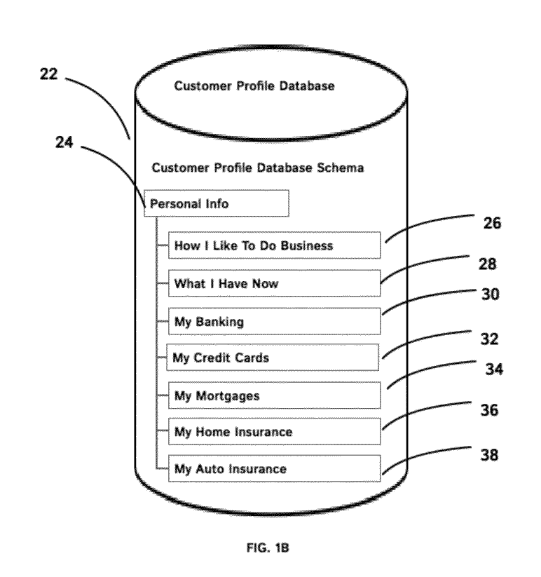

Referring to FIG. 1, graphical representation 2 of a personal profile is shown. Graphical representation 2 displays the various types of information that are included in a personal profile, including, e.g., personal information 4, business preference information 6, current holding information 8, banking information 10, credit card information 12, mortgage information 14, home insurance information 16, and auto insurance information 18.

In an example, a user completes a personal profile through a series of graphical user interface (GUI) screens. A personal profile includes information related to a user's personal information, information indicative of financial products associated with the user, and preferences for how the user likes to do business. Financial products include current and desired credit cards, mortgages, insurance, bank accounts, and other financial products. Preferences include what products the user currently has, how he/she likes to do business with current financial product providers, and how he/she would like to do business with financial product providers in the future. The first GUI screen is for entering personal information 4, such as name, address, zip code, occupation, income, and similar information that is independent of financial products. On the next GUI screen, the user enters business preference information 6, e.g., information specifying how the user likes to do business with financial companies. This type of information specifies whether the user prefers to do business in person, at a branch office, over the phone, via the Internet, etc. The next GUI screen is for the user to enter current holding information 8 that indicates which financial products the user currently holds. Financial products would include their current credit cards, bank accounts, mortgages, home insurance, auto insurance, and other financial products. Next, the user would enter banking information 10 about the user's current bank accounts. This type of information would include the name of the banking institution, how they use their bank, and other details about the banking services the user currently receives. Next, the user enters credit card information 12 about the user's current credit cards. This type of information includes the name of the credit card and credit card institution, interest rates, current balances, rewards systems, how they use their credit cards, and other details about the credit cards the user currently uses. The next GUI screen is for entering mortgage information 14 about the user's current mortgages. Mortgage information includes property information including address and property value, mortgage information including lending institution, original mortgage amount, interest rate, mortgage terms, amount currently remaining on mortgage, and other related mortgage information. The next GUI screen in the process is for the user to enter home insurance information 16 about the user's current home or renter's insurance. This type of information includes the name of the insurance provider, the current premium, and the current coverage. The next GUI screen is for the user to enter current auto insurance information 18, including the name of the insurance provider, the premium amount, and the current coverage. In a variation, the personal profile includes other types of information, including, e.g., information about other products, such as investments, health insurance, utilities, and cell phone plans.

After the some or all of the personal profile information is completed by the user, this information is stored in a customer profile database 22. The schema for this database includes tables that correspond to each of the types of information included in the personal profile, including e.g., a personal information table 24 for storing personal information 4, business preference table 26 for storing business preference information 6, current holding table 28 for storing current holding information 8, banking information table 30 for storing banking information 10, credit card table 32 for storing credit card information 12, mortgage information table 34 for storing mortgage information 14, home insurance information 36 for storing home insurance information 16, and auto insurance information 38 for storing auto insurance information 18.

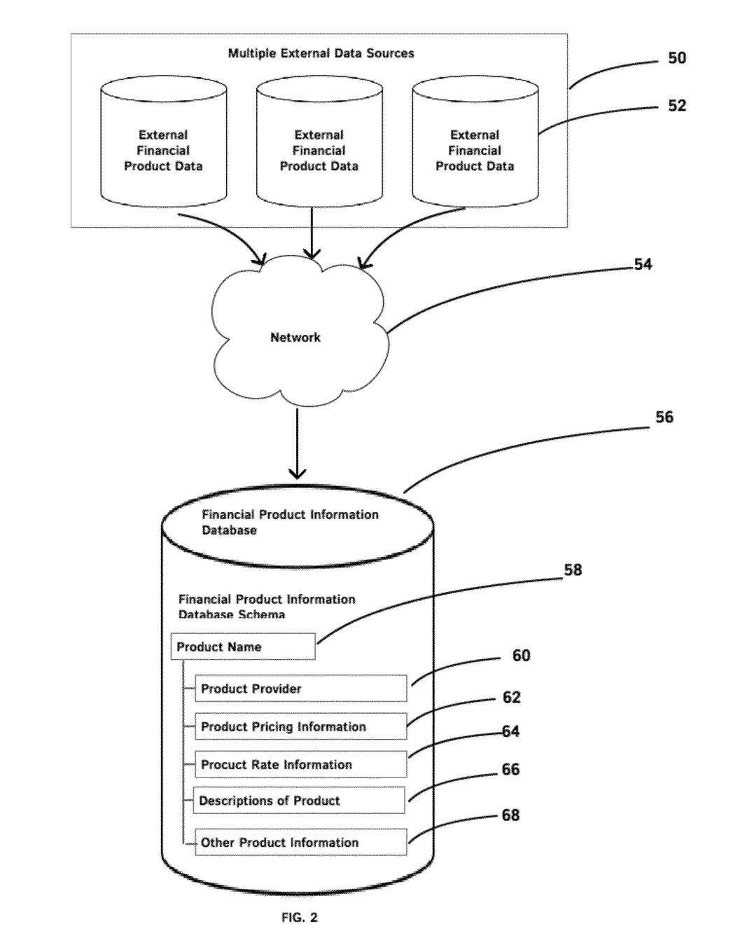

Referring to FIG. 2, data about financial products is collected from multiple external data sources 50, transferred via a network 54, and stored in a financial product information database 56 (through a system). In operation, a system (not shown) collects external financial product data 52 from various external and internal data sources. This data includes information about the products and pricing currently offered to consumers for bank accounts, credit cards, mortgages, home insurance, auto insurance, and other similar financial products. There are various types of data sources, including, e.g., databases purchased from third parties, data collected independently by staff, data gathered from customers of financial providers via surveys, telephone calls, and interviews, data gathered from interviews of financial product providers, data gathered from social media sentiment, and data from independent news and information sources. The network 54 includes the Internet and any other means of transferring this data into a financial product information database 56. This financial product information database 56 includes the following scheme for an individual financial product: a product name table 58, a product provider table 60 for specifying the name of the provider, address, contact information, and unique internet link to the provider's product webpages, a product pricing information table 62, which includes the current and historical pricing or rate information for a product, a description of product table 66, which includes an overview about the product, its unique characteristics designed for specific users, and any other information that a consumer may find interesting about the product, and other product information table 68, which would include other information from internal and external financial product data sources that promotes making product recommendations to consumers in the future. There are various types of financial products including bank accounts, credit cards, mortgages, home insurance, auto insurance, and so forth.

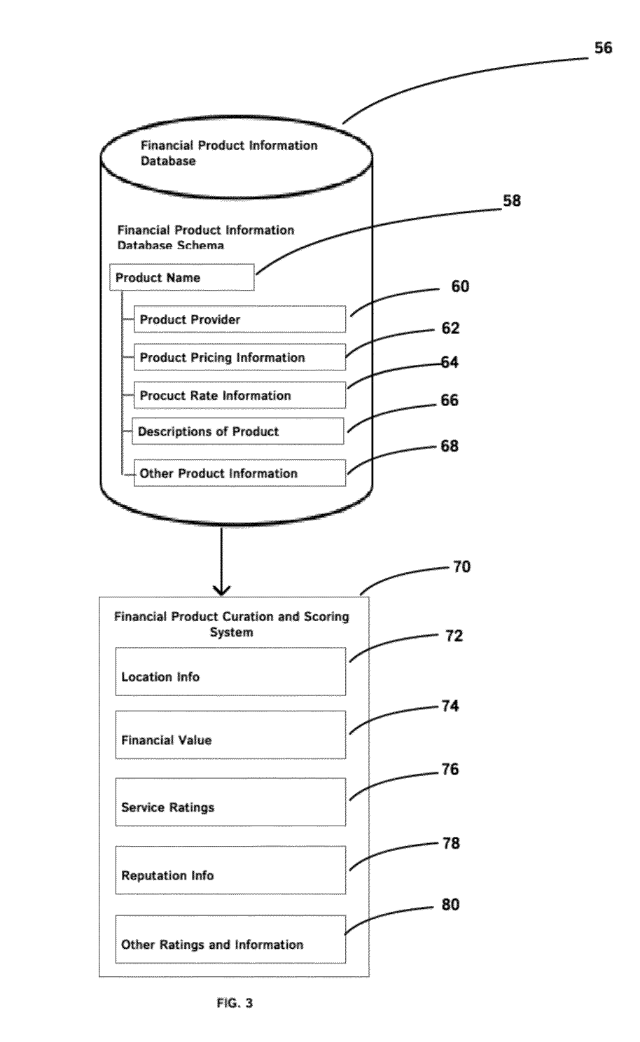

Referring to FIG. 3, the information found in the financial product information database 56 is appended (e.g., by a system) with scores and ratings from a financial product curation and scoring system 70, which is used later for generating a unique rating for each financial product. Financial product curation and scoring system 70 includes a rating and score for attributes of individual financial products and financial product providers, including but not limited to ratings for location, financial value, service ratings, reputation, product features, and other ratings information. Location information rating 72 includes a rating score indicative of how appropriate the product or provider being rated is for a consumer based on the consumer's location. Financial value rating 74 is a rating score based on the financial value related to pricing, rate and other financial considerations for the product that would be relevant to a consumer. Service ratings 76 are ratings and scores related to how well the company performs customer service over the telephone, in person, at branches and offices, over the internet, and any other service channels at which the company does business and which are determined that consumers find value. Reputation information rating 78 includes rating and scores based on the provider's reputation as determined by what other customers of a company say about that company and how it is to do business with the company, as well as third-party ratings systems and how they rate the company. Other ratings information 80 includes ratings that are specific to product types, such as rating categories specific for a credit card that would not be appropriate for other financial products, or rating categories for a mortgage that might not be appropriate for other products.

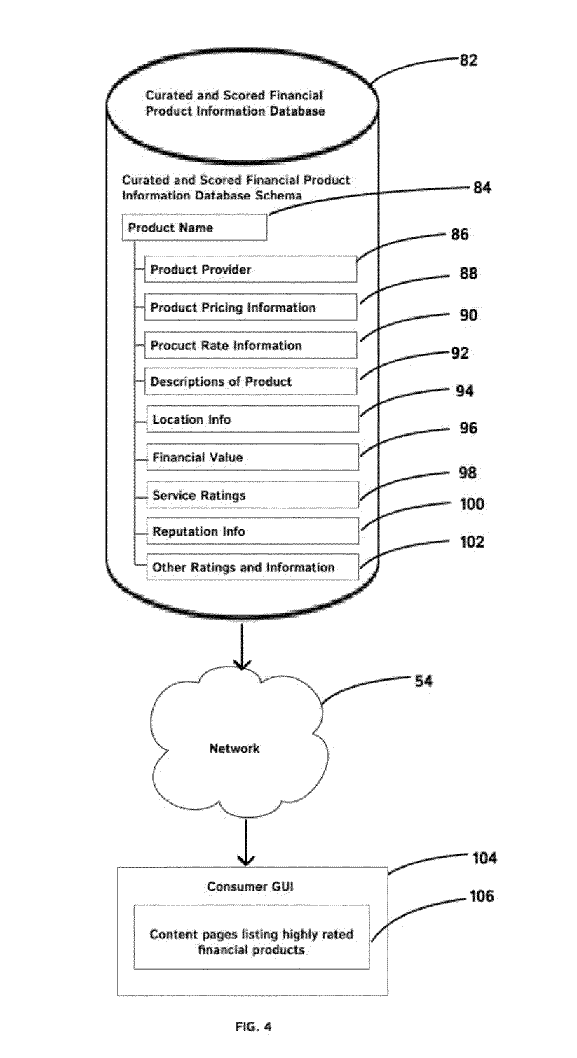

Referring to FIG. 4, curated and scored financial product information database 84 is an updated version of database 56 (FIG. 3), in which the curation, scoring and ratings have been added. The system curates, scores, and rates products by starting with the universe of thousands of available products and financial providers in each product category. These are then filtered according to which locations (states, zip codes, counties, cities) in which each product is offered, then apply a filter through which pass only the established and legitimate providers, then we apply a further filter to identify companies that do a significant amount of business in a given geographic location, and then we filter on criteria that determine customer value, such as price, interest rates, fees, etc. Other filters are also applied, including product incentives offered consumers, benefits such as warranties and insurance, and the overall reputation of the product and provider. A scoring rubric is then applied to determine a score on a scale of 0 to 100, as described in further detail below. The curated and scored financial product information database 84 includes the following tables for a particular financial product and/or financial product provider. These tables include: the product name table 84, the product provider table 86 for storing the product provider name and information such as address and contact information, product pricing information table 88 for storing information indicative of rates and prices, product rate information table 90 for storing information including interest rates and fees charged for a product, description of product table 92 for storing information indicative of an overview description about a financial product or provider, location information table 94 for storing information specifying geographical locations such as states, cities and zip codes that the product is of the highest value and the rating for this product in certain geographical locations, the financial value rating table 96 which specifies how the product has been scored and rated, a service ratings table 98, which includes the service ratings, a reputation info ratings table 100, which would include the rating and scoring information entered into the system for a product reputation, and other ratings and information table 102 which would include any other ratings entered into the system. This information from the curated and scored financial product information database 82 is displayed on a client device as a consumer GUI 104 via a network, which may include the Internet or other networks that convey information to the user. This consumer GUI 104 is rendered via web pages, mobile phone applications and website, and other content accessible by consumers over public networks. Consumer GUI 104 displays highly rated financial products 106, e.g., financial products with increased relevance to the consumer, relative to relevance of other financial products to the consumer. In an example, a rating for a financial product is determining by summing or averaging a service rating or a financial value rating, as described in further detail below. Highly rated products and companies are determined by a blended rating of the product and company value, incentives for consumers, benefits and perks for consumers, and overall reputation based on consumer opinions and expert ratings. The content pages listing highly rated financial products includes the information stored in the curated and scored financial product information database 82 for the particular financial product that is highly rated.

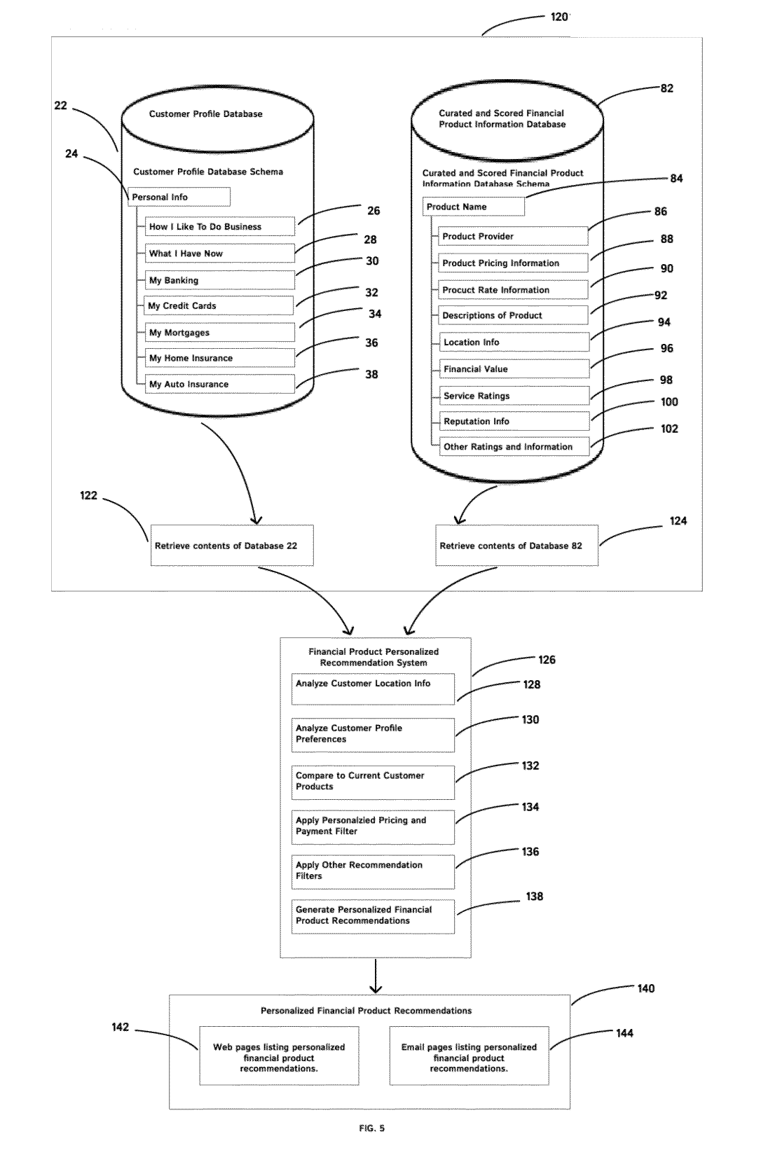

FIG. 5 shows a financial product recommendation process 120 in which the customer profile database 22 and the curated and scored financial product information database 82 are combined through a financial product personalized recommendation system or engine 126 (including one or more algorithms), which in turn generates financial product recommendations for a specific consumer. Process 120 is implemented by a system (not shown). In operation, the system retrieves (122) the attributes in the customer profile database 22 and retrieves (124) attributes of the curated and scored financial product information database 82, eliminating products in the curated and scored financial product information database 82 that are not appropriate for the consumer based on their customer profile database 22, as described in detail below. The resulting set of personalized financial product recommendations 140 is a customized subset of the original curated and scored financial product information database 82. Financial product personalized recommendation engine 126 generates these recommendations 140. In operation, engine 126 analyses (128) customer location information (for example, where the consumer lives and works as specified in personal information table 24) and analyses (130) the customer profile preferences (as specified in business preference table 26). Engine 126 compares (132) customer location information and profile preferences to current customer products (if entered by the consumer and as specified in table 28) and attributes of various financial products and applies (134) a personalized pricing and payment filter, which eliminates products based on the pricing and payment needs completed by the consumer and stored in the customer profile database 22 and the attributes of the financial products. In this example, products are eliminated when there is a mismatch between a consumer preference and an attribute of a financial product, e.g., when a financial product is unable to meet the needs and/or preferences of the consumer. In an example, financial products that the consumer does not currently or that the consumer has indicated a need for are recommended. Pricing needs may include the minimum savings required by the consumer to change product providers or product types, or modifications to the current product the consumer has, or other thresholds. Matching is generated by an algorithm that takes into account the consumer's location, budget, spending habits, credit score, family situation, preferences for conducting business both online and in person, occupation, age, debt situation, and other personal financial situations. This recommendation process would also be duplicated according to a schedule determined the consumer. For example, a consumer would choose to have products recommended monthly. This process, which is a monitoring process, would then occur each month, with the consumer receiving a notification that new recommendations have been generated by the system.

Engine 126 also applies (136) other recommendation filters. Based on application of the filters, engine 126 generates (138) a personalized financial product recommendation 140, which may be presented or transmitted to consumers on web pages listing personalized financial product recommendations 142, e-mail pages listing personalize financial product recommendations 144 as well as other software applications listing these recommendations. Process 120 is implemented periodically (e.g., on an ongoing basis), based on the preferences of the consumer, changes to the customer profile database, changes to the curated and scored financial product information database, and the logic programmed into the system.

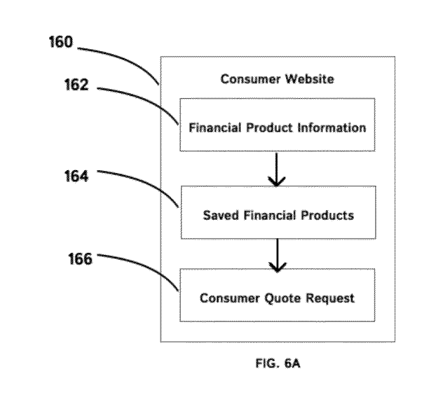

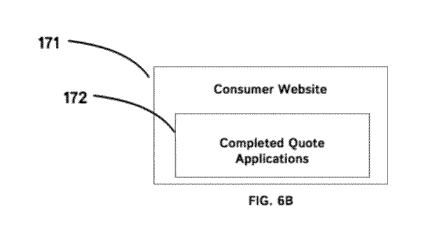

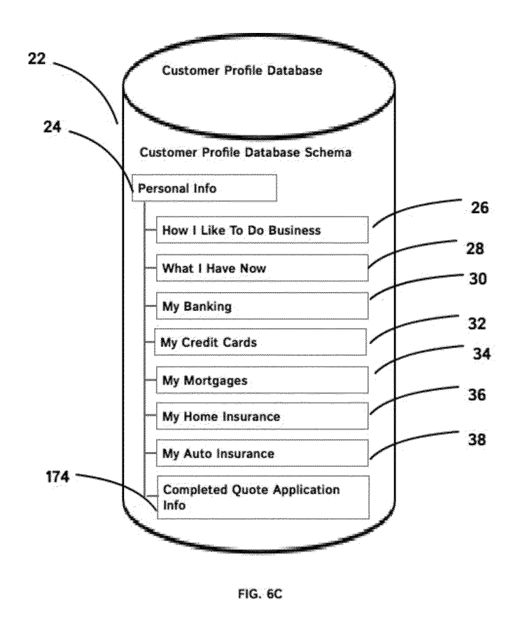

Referring to FIG. 6A, a graphical representation 160 of a consumer website (hereinafter “consumer website 160”) is shown. Consumer website 160 allows consumers to receive multiple price quotes at once, without filing out multiple forms or providing personal contact details. A price quote is the cost or payment for a financial product. For example, a price quote includes the monthly payment amount for auto insurance, or the payment information for a new mortgage. In this example, a consumer visits a consumer website 160 (or similar software application) to provide personal information to receive a price quote on a financial product from a financial product provider. For returning consumers, some or all of this information may be stored in the customer profile database 22 (FIG. 1B), so that the consumer can avoid re-entering information, or sharing personal contact information directly with a provider. This website 160 lists financial product information 162 for individual financial products. The website 160 also lists saved financial products 164, which are products the consumer has indicated an interest in during this or previous usage of the consumer website or similar software application. The consumer website 160 will also generate a request 166, or multiple requests, for a personal price quote from a financial provider. This request is sent over e a network to a recommendation system. The recommendation system associates, in database 22, the request with the consumer's profile. The system sends an email or text notification to a client device used by the consumer.

Referring to FIG. 6B, through the notification, the consumer is alerted to visit a consumer website 171 or similar software application to view the completed quote application 172. The consumer approves the completed quote application, which may be for multiple quotes. Information for these consumer quote applications is sent to the recommendation system, which stores the completed quote application in database 22. Referring to FIG. 6C, customer profile database 22 is updated with, complete quote application information table 174 to store the complete quote application information.

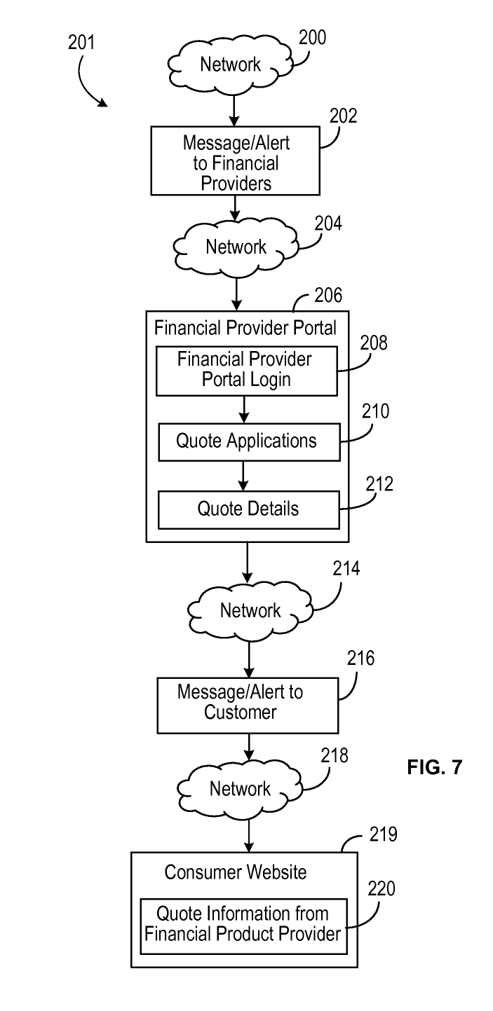

Referring to FIG. 7, networked environment 201 includes a financial provider portal 206 that enables financial product providers to view consumer quote applications, and to append these quote applications with quotes and pricing information for the consumer's review. The recommendation system generates data for the financial provider portal 206, that when rendered on a display device of a financial product provider displays the portal. The recommendation system also sends messages to consumers about the status of financial quote requests, and allows consumers to review quote and pricing information provided by providers all in one place, and using a common set of consumer preferences. In this example, the recommendation system sends (via network 200) a message or alert 202 to specific financial providers selected by a consumer. For example, the consumer can specify which providers are to provide quotes. This message may be an e-mail message or an alert visible on a website or software application. The provider connects over a network 204 to the financial provider portal 206. The financial provider portal includes a secure financial provider portal login 208 process. After logging into the portal 206, the financial provider can view completed consumer quote applications 210. Next, the financial provider can add quote details 212 for the consumer to view. The consumer is notified over the network 214 via a message or alert 216, which may be delivered via email, text, or instantly while the consumer is still on the website or consumer application described in the process on FIG. 6. This message will instruct the consumer to view their quote and other pricing information from the financial provider. The consumer visits a consumer website 219 or software application and views his/her completed financial product quote information 220 that is received from the provider. In this example, networks 200, 204, 214, 218 include a same network, e.g., the Internet. In another example, networks 200, 204, 214, 218 may include differing networks.

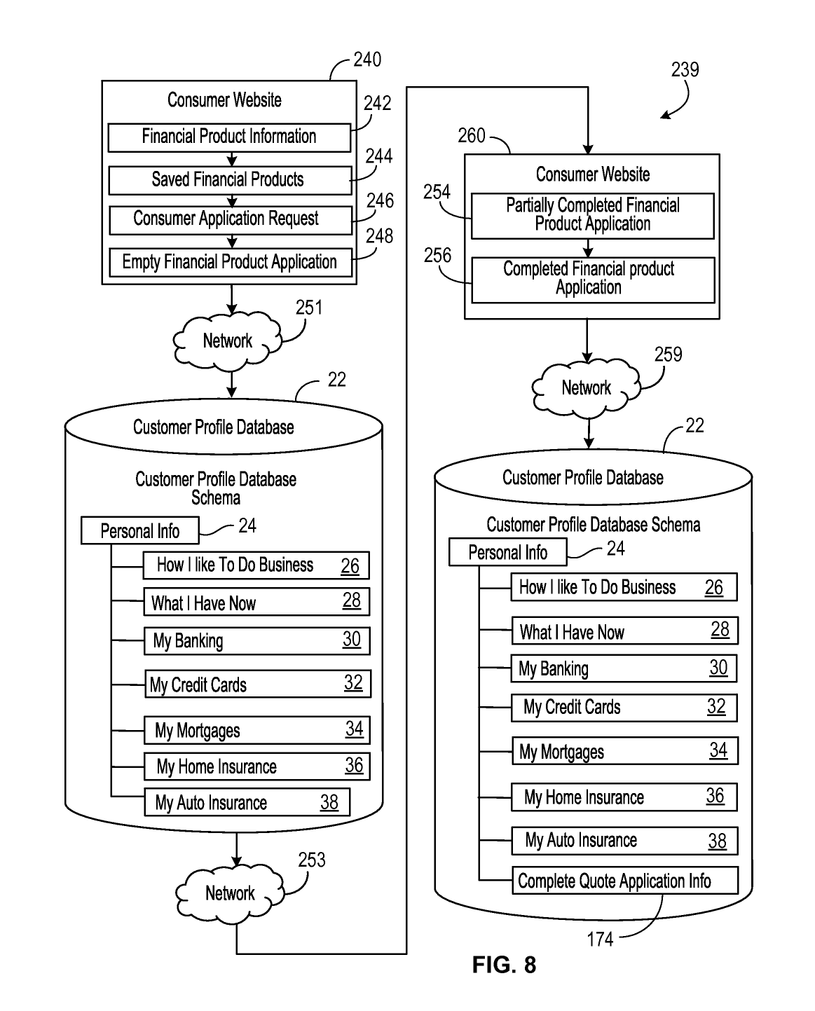

Referring to FIG. 8, networked environment 239 enables a consumer to visit a consumer website 240 (or uses a consumer software application) to make a full application for a specific product selected by the consumer. Full applications convey consumer information required to secure a product and includes information for a provider to approve, deny, and price a consumer application. This recommendation system allows consumers to apply for multiple financial products at once, without filing out multiple forms or sharing sensitive, personal information across multiple provider application websites. The consumer is able to apply for these financial products by providing less information about himself/herself, because most of his/her information is already stored in the customer profile database 22. This process begins when a consumer visits a customer website 240 or similar software application. This website includes financial product information for individual financial products 242. The website 240 also includes information representing saved financial products 244, which is a list specifying products that have been reviewed by the consumer (e.g., either currently or previously). The consumer website 240 enables a consumer to request 246 a consumer application for one or more financial products. In response, consumers are presented with an unpopulated (e.g., empty) financial product application 248 and the option to fill the application using the information in the customer profile database 22, which has been saved by the consumer previously. In an example, a portion of the empty application is completed using contents of the consumer profile database 22, shared via the network 251. In this example, a partially completed application is transmitted via network 253 to a client device of the consumer, e.g., for display in consumer website 260. Through consumer website 260 (which is an updated version of consumer website 240), the consumer views the partially completed financial product application 254 and completes the application with extra information needed to complete the application. This completed financial product application 256 is sent via network 259 and new information is stored in the customer profile database 22, in new tables for completed quote and application info 174.

Referring to FIG. 9, networked environment 279 enables a financial product provider to interact with a provider portal and view full product applications, approve, deny, and price these applications, as well as provide information for consumers about the application status and decision. The recommendation system (not shown) also allows for messaging to consumers about the status of a full application over a network. The system transmits a message or alert 282 to financial providers sent over a network 280 indicating a consumer has completed a full application for a specific financial product. This message may be an email message or an alert visible on a website or software application. The provider connects over a network 283 to a financial provider portal 284. The financial provider portal includes a secure financial provider portal login 284 process. After logging into the recommendation system, the provider can view completed consumer financial product applications 288 for that provider's products. The provider can approve, deny, and/or price full applications and enter application approval/denial details 290 for the consumer to view. The consumer is notified over the network 291 via a message or alert 292, which may be delivered via email, text, or instantly while the consumer is still on the website or consumer application described in the process on FIG. 8. This message will instruct the consumer to view application information from the financial provider.

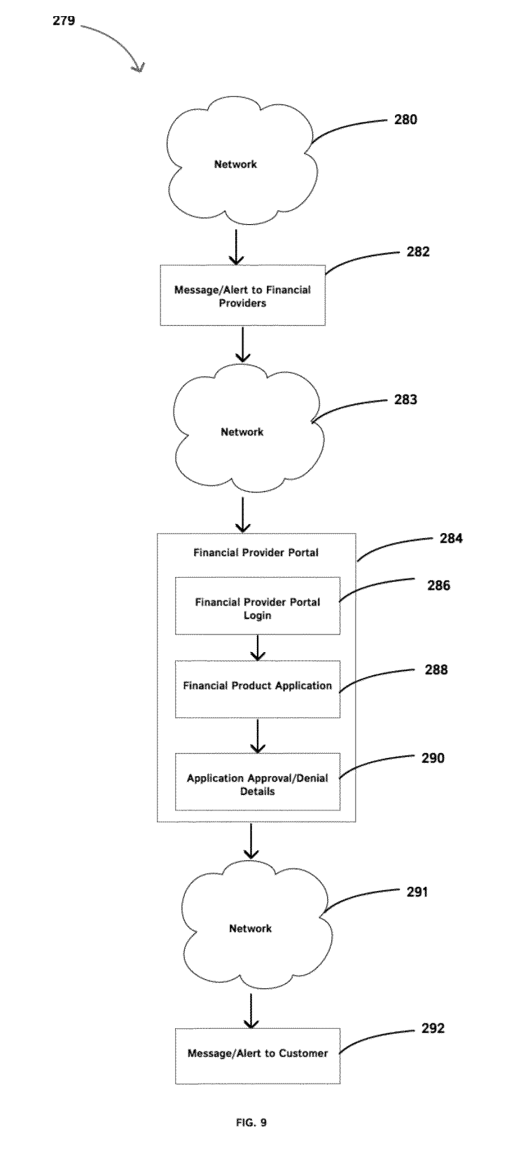

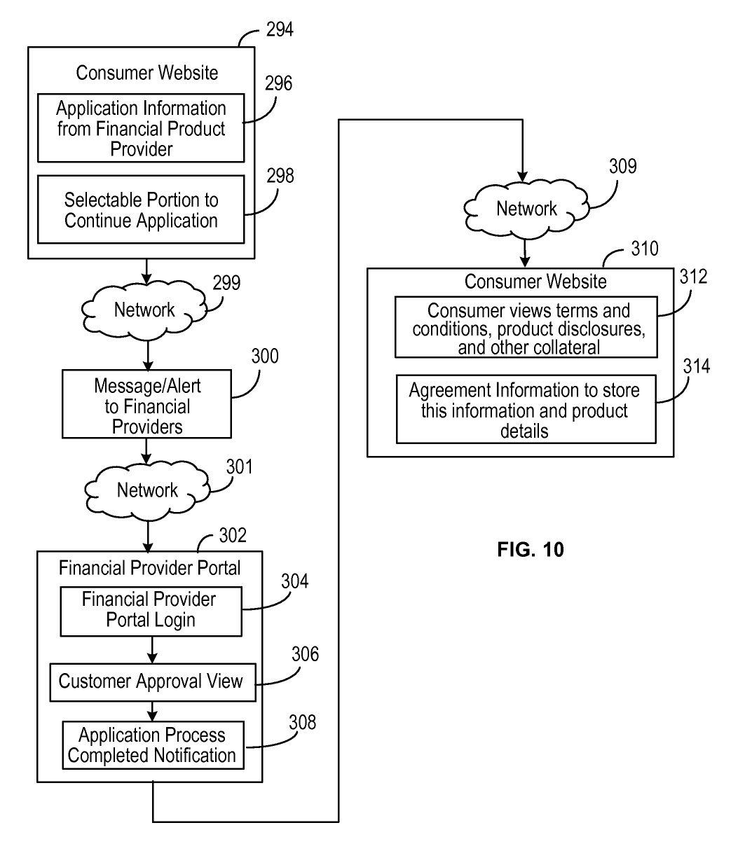

Referring to FIG. 10, networked environment 293 provides for a consumer to receive approval from one or more financial product applications. In this example, the consumer selects (in a GUI) information indicative of the financial product, and is connected to the provider to complete the application process and to obtain the financial product. On consumer website 294, the customer may view his/her application information from financial product providers 296 and also decide (e.g., via selectable portion 298) if he/she would like to continue with an approved application. When the customer decides to continue with an application the financial provider is notified via the network 299 by receiving a message or alert 300 that the consumer would like to continue the process. The financial provider visits a financial provider portal 302 via the network 301, logs into the financial provider portal using a secure financial provider portal login 304. Next, the financial provider views the consumer's approval details 306. The application process is now complete and the website is updated to display an application process complete notification 308. Following completion, the consumer may obtain the financial product. Via the network 309, the provider conveys the terms and conditions, product disclosures, and other collateral 312 through the system to the consumer website 310. The consumer website 310 provides a choice to the consumer to store this information 314 and product details in the consumer profile database 22 (FIG. 1B).

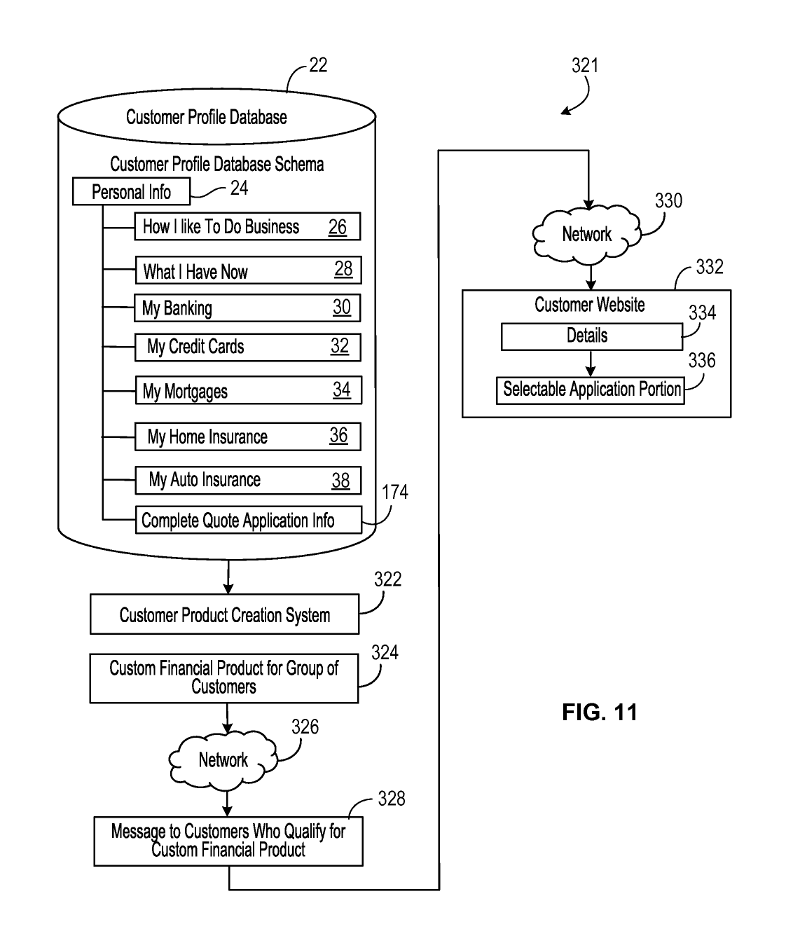

Referring to FIG. 11, networked environment 321 enables generation of custom financial products, based on the consumer's specific situation and needs. Networked environment 321 includes recommendation system 322 for generating custom financial products. For example, the recommendation system 322 determines that various customers in the customer profile database 22 (FIG. 1B) live in the same zip code and needed to renew auto insurance. In this example, recommendation system 322 generates a custom auto insurance policy with a discount for this group of consumers and/or special localized features for this group. Financial products eligible for customization include bank accounts, credit cards, mortgages, home insurance, auto insurance, and other financial products. In operation, recommendation system 322 analyzes consumer information stored in the customer profile database 22. Based on the analysis, recommendation system 322 identifies common characteristics of consumers and common product needs of consumers through a software matching algorithm. For example, recommendation system 322 may determine a group of consumers with a car insurance deductible (as specified in auto insurance table 38) that is above a threshold amount and that live in a particular geographic location (e.g., as specified by personal information 24). Once a need is discovered (e.g., a need for car insurance with a lower deductible in a particular geographic location) for one or many customers in the system, recommendation system 322 generates custom financial product 324, e.g., by facilitating with insurance providers a group discount. Custom products may be generated in many different ways based on the needs of a group via computer algorithm to determine common characteristics in the base of consumers. For example, a single auto insurance product may be created for a group of consumers who all need to renew their auto insurance at the same time and/or same general location or type of auto. Or a credit card could be created for a group of consumers interested in the same type of rewards. Or the system could create a product that would receive the highest possible score in the rating system. Qualifying consumers are notified over a network 326 with a message 328 to customers who qualify for custom financial products 324. This message could be delivered as email, text message, or other communication methods. Consumers access a consumer website 332 or client software application to view details 334 about the custom financial product 324. Consumer website 332 includes a selectable portion 336, selection of which enables consumers interested in the custom financial product to apply for the product.

Referring to FIG. 12, networked environment 349 enables a consumer to generate a digital image of a financial product statement or other consumer bill and upload the image of the financial statement through a network, where the image is then processed through a financial statement imaging process, relevant data is extracted from the image, the image is deleted and the relevant data is stored in the customer profile database. This allows the consumer to simplify the process of determining if a different product would better suit his or her needs. Networked environment 349 includes client device 350 (e.g., a mobile phone or personal computer device). Using client device 350, the consumer scans (352) or takes the photograph of a financial statement. Financial statements include bank account statements, credit card statements, mortgage statements, auto and home insurance policy statements and coverage details, and other similar financial statements, as well as periodic bills for consumer services such as mobile phone bills and plans. Once the consumer has created an image of the statement, client device 350 uploads (354) the image of the financial statement over the network 356 and into a system 358 for financial statement image processing (e.g., the recommendation system). In a variation, the consumer uses a mobile phone application to convey the image to the system. This financial statement image processing system 358 processes (360) the users financial image statement, extracts (362) relevant user financial data and personal profile information 362, and deletes (364) the financial statement image 364. The extracted relevant consumer profile information is stored in the customer profile database 22 in the appropriate tables in the customer profile database schema. This information can then be used in the future to help consumers find better financial products related to the financial product for which the original image statement was processed. The multiple networks included in each of FIGS. 7-12 may be a same network or different networks.

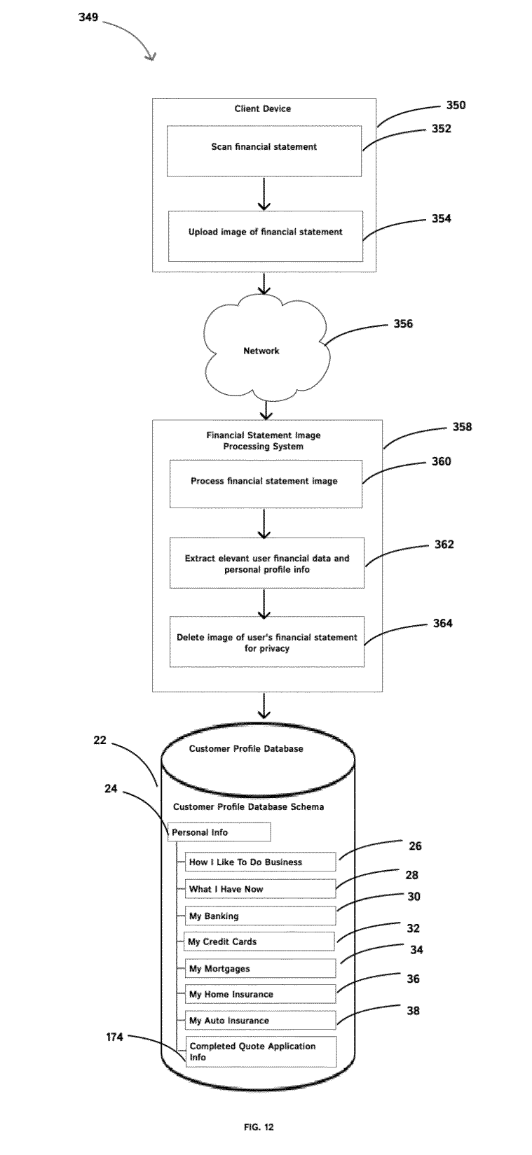

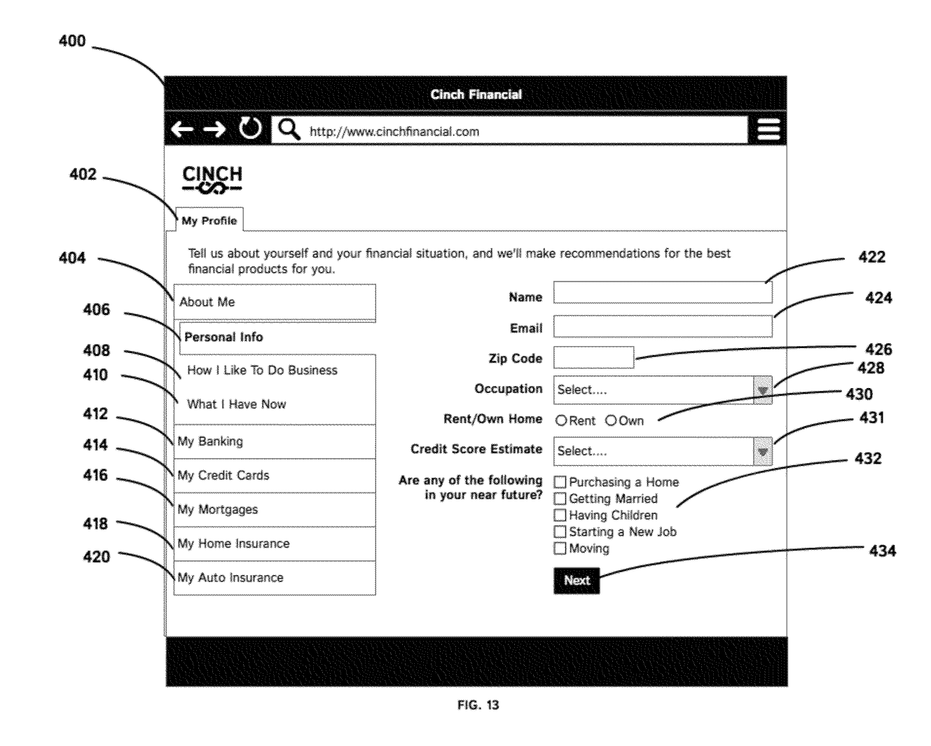

Referring to FIG. 13, GUI 400 enables a consumer to enter personal information, which is stored and used in the system described in FIG. 1 in which consumer personal and financial information is stored in a customer profile database 22. GUI 400 includes a section labeled my profile 402, which includes an about me section 404, a personal information section 406, a how I like to do business section 408, a what I have now section 410, a my banking section 412, a my credit cards section 414, my mortgages section 416, my home insurance section 418, and my auto insurance section 420. In a variation, a GUI could also include sections for other financial product similar to bank accounts, credit cards, mortgages, home insurance, and auto insurance. Using personal info section 408, a consumer enters in personal information, such as name 422, email address 424, zip code 426, occupation or job information 430, home ownership status 430, credit score estimate 431 and events that may happen in the future 432, such as purchasing a home, getting married, having children, starting a new job, moving, etc. GUI 400 is used to generate a profile of a consumer that will be analyzed via a computer algorithm to recommend financial products to the consumer. A personal profile is information specific to that consumer that promotes determination of correct financial product for his or her needs. Data entered into this GUI 400 would not be limited to the data fields illustrated here. These have been placed here for examples, but other general information about consumers could be added. Once a consumer completes this profile, he/she saves this information with the “next” button. This personal information is saved, by a recommendation system, in a customer profile database 22 for later use in assisting and recommending bank accounts, credit cards, mortgages, home insurance, auto insurance, and other similar financial products to the consumer.

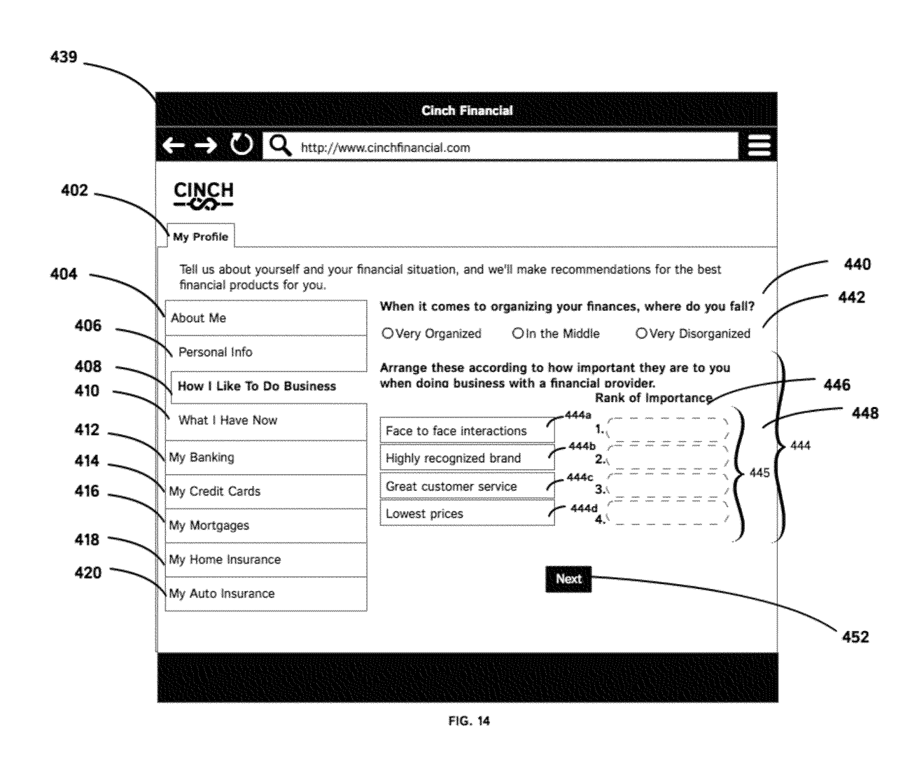

Referring to FIG. 14, GUI 439 is an updated version of GUI 400 in which the how I like to do business section is selected. GUI 439 enables a consumer to indicate the consumer's preferences when doing business with financial service providers. GUI 439 includes portion 440 and controls 442 for consumers to specify a level of financial organization. GUI 439 also includes section 444 for a consumer to rank various attributes 444a-444d. Section 444 includes ranking list 445 for a consumer to rank attributes 444a-444d. Here the consumer would arrange the most important elements from top to bottom, most important to least important in terms of preference. Ranked attributes would include face to face interactions, highly recognized brands or companies, great customer service, and lowest prices. Data entered into this GUI 439 would not be limited to the data fields illustrated here. These have been placed here as examples, but other attributes measuring consumer preferences in selecting and working with financial product providers could be added. Once a consumer completes this profile, the consumer saves this information with the Next button 452. Following section of the Next button 452, the recommendation server receives a request to store the information entered into GUI 439 and saves this information in the customer profile database 22 for later use in recommending bank accounts, credit cards, mortgages, home insurance, auto insurance, and other similar financial products to the consumer.

Referring to FIG. 14, GUI 439 is an alternative or complementary method for consumers to define their financial product needs by selecting a specific situation (e.g. having a baby, moving, traveling overseas) or lookalike profile (e.g. single with new job, newly married couple, first baby on the way, family starting a home search, etc.) that will determine needs and preferences in a financial product. Data entered into this GUI 439 would not be limited the data fields illustrated here. These have been placed here as examples, but other attributes measuring consumer preferences in selecting and working with financial product providers could be added. Once a consumer completes this profile, the consumer saves this information with the Next button 452. Following section of the Next button 452, the recommendation server receives a request to store the information entered into GUI 439 and saves this information in the customer profile database 22 for later use in recommending bank accounts, credit cards, mortgages, home insurance, auto insurance, and other similar financial products to the consumer.

Referring to FIG. 15, GUI 455 shows the elements that are displayed, following selection of what I have now section 410. GUI 455 includes section 460 for specifying the consumer's current financial products via controls 462a-462e. Through selection of one or more of controls 462a-462e, the consumer indicates if the consumer currently has a bank account, credit cards, mortgages, home insurance, and/or auto insurance, respectively. This would enable this system to ask questions about these financial products later to enrich the profile. Data entered into this GUI 455 would not be limited to the financial products illustrated here. These have been placed here as examples, but other financial product types could be listed in the future. Once a consumer completes GUI 455, the consumer causes the recommendation system to save this information through selection of next button 464. Information specifying the products selected is saved in a customer profile database 22 for later use in assisting and recommending bank accounts, credit cards, mortgages, home insurance, auto insurance, and other similar financial products to the consumer.

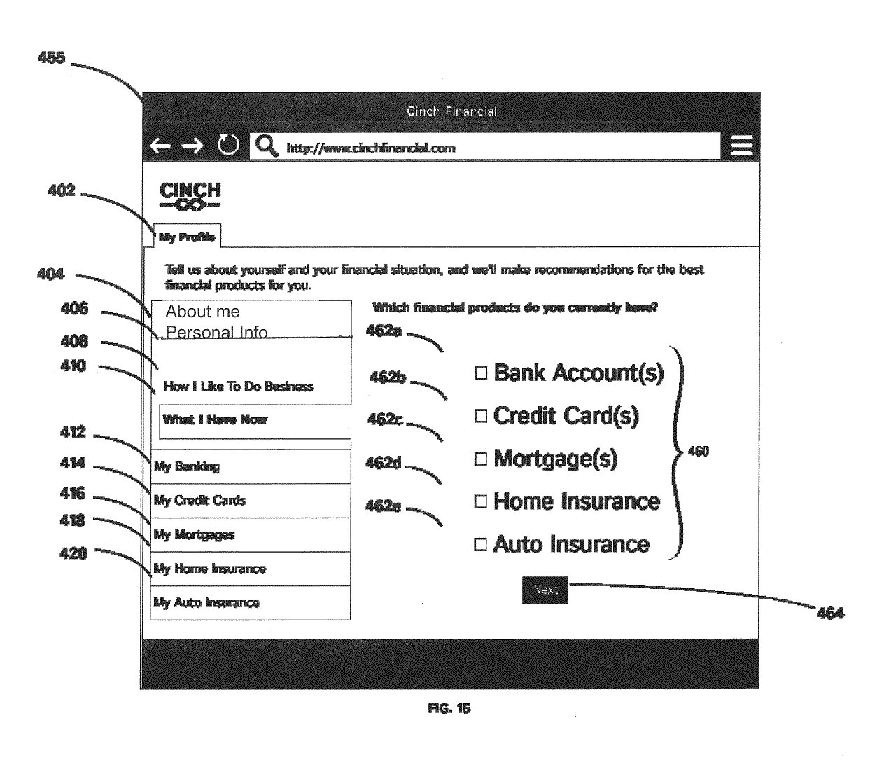

Referring to FIG. 16, GUI 465 is displayed, following selection of my credit cards section 414. GUI 465 includes section 470 for entering details about a consumer's current credit cards. Section 470 includes field 474 for entering information specifying a name of a credit card provider, field 476 for entering information specifying amount spent per month in dollars, field 478 for entering information specifying current balance in dollars, field 480 for entering information specifying current interest rate in percentage, selectable control 482 for selection a type of card rewards 482 (e.g., rewards given when a credit cards is used, including, e.g., cash rebates, airline mile points, hotel points, etc.), and selectable control 483 for specifying credit card features that are most important, including, e.g., low interest rate, low annual fee, no foreign transaction fees, and so forth. Once a consumer completes this GUI 465, the consumer could finish entering credit cards by selecting finished control 486 or enter information about another credit card by selecting add another card control 484. The information entered here by the consumer is saved via a network in a customer profile database 22 for later use in assisting and recommending credit cards to the consumer. In a variation, there are similar GUI screens for the consumer to enter information about current bank accounts, debit card, mortgages, home insurance, auto insurance, and other similar financial products.

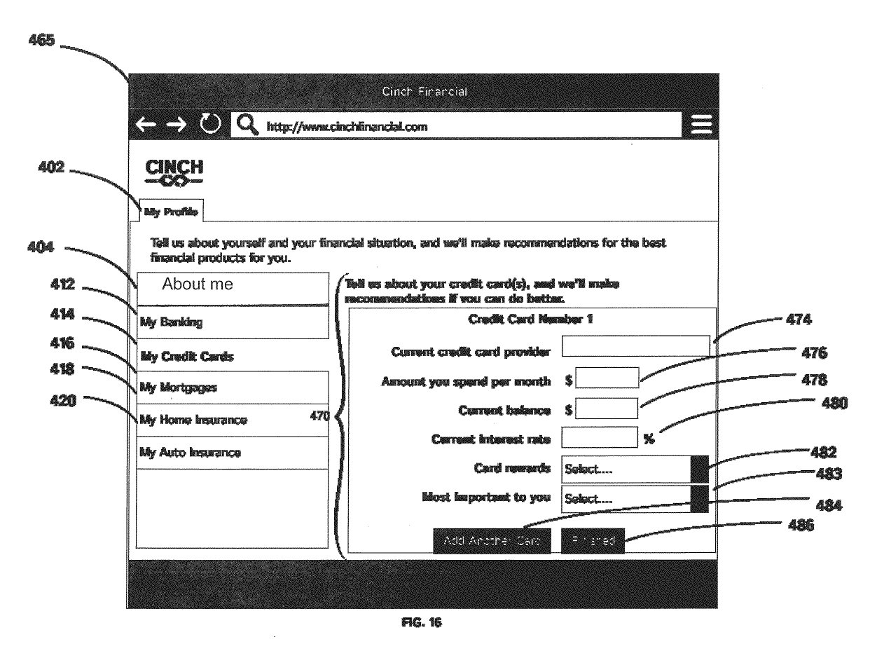

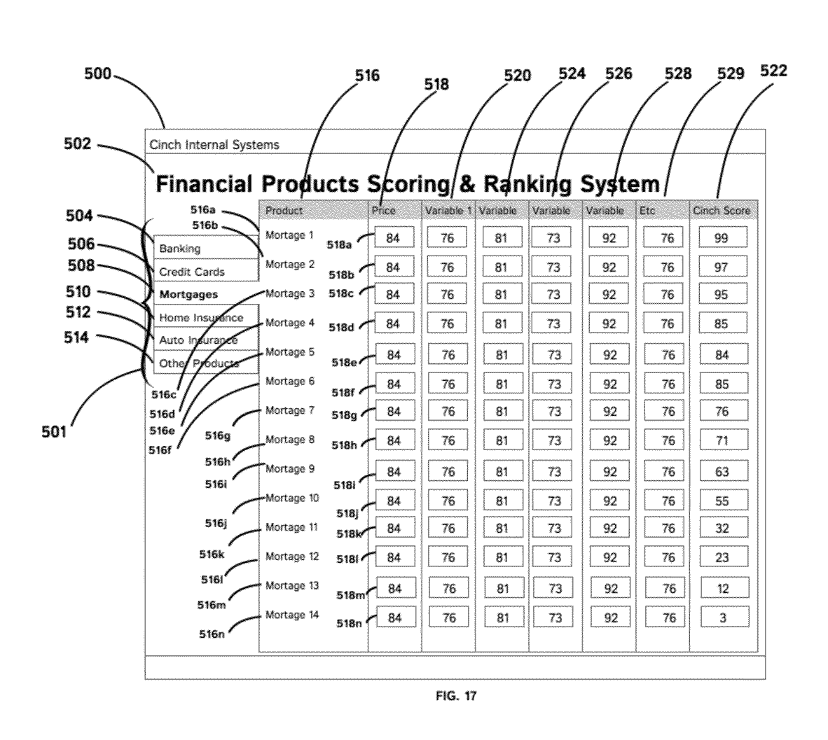

FIG. 17, GUI 500 displays information to aid the consumer in selecting the right product (and is used by analysts researching and scoring products). GUI 500 includes title portion 502 to specify that GUI 500 displays information that is based on ranking data for financial products that is entered into a financial products scoring & ranking system. GUI 500 includes menu 501 for selecting various types of products for which scores and ranks are displayed. In this example, menu 501 displays scores and ranks for various mortgage products, following selection of mortgage section 508 of menu 501. Menu 51 also includes banking section 504, credit card section 506, home insurance section 510, auto insurance section 512, and other products section 514, selection of which displays rankings and scores for bank accounts, credit cards, home insurance, auto insurance, and other similar financial products, respectively.

In this example, GUI 500 includes product section 516 that lists various products 516a-516n, e.g., mortgage products. A mortgage product is evaluated across multiple variables, including, e.g., price and so forth. For mortgages, variables include: the quality of the website, phone service, ease of application, quality of phone service, availability of local offices, closing rates, closing costs, denial rate, amount of loans the provider sells to third parties, percentage of customers who leave provider for another provider, customer reviews and commentary on other websites, expert opinions, percentage of complaints to the Consumer Finance Protection Board (CFPB), interest rates, among other mortgage attributes. For credit cards, variables include, quality of credit card rewards, annual percentage rate, annual fees, length of billing grace period, other fees, additional incentives, promotional interest rates, warranties, purchase protection, EMV chip presence, merchant acceptance, car rental insurance, travel insurance, CFPB complaints, expert reviews from third parties, and consumer reviews from social networks and websites. For home and auto insurance variables include pricing, customer retention, flexible claims procedures, location convenience, website quality, local agent availability, reviews and commentary from customers on other websites and social media, expert ratings, and state agency ratings. Variables for checking and savings bank accounts include monthly fees, minimum balance requirements, ATM fees, check ordering fees, overdraft fees, interest earned, only bill payment and check writing, website quality, ATM availability, local branch hours, phone service hours, CFPB complains expert reviews, and reviews and comments on other websites and social media.

In this example, GUI 500 includes variable portion 518 with fields 518a-518n for entry of values for the variable specified by variable portion 518 (i.e., price). For example, a user enters a score in field 518a for product 516a, field 518b for product 516b and so forth. In an example, for each mortgage, analysts enter several scores that are values for the variables, ranking each mortgage for that scoring attribute. GUI 500 also includes variable portions 520, 524, 526 and 528 and 529, each of which includes associated fields for entering values of the respective variable. Using the values for the various variables (as specified by the values entered into the fields of variable portions 518, 520, 524, 526 and 528), the recommendation system calculates a propriety score for each of products 516a-516n. GUI 500 includes proprietary score section 522 for display of a calculated proprietary score, for each of products 516a-516n.

For example, the proprietary score may be based on a summation, an average, a mean and so forth, of the scores of the variables for a product. Mathematical formulas are applied (by a system) to the values of the variables to generate the proprietary score, as described in further detail below. This score would be used to assist consumers in understanding which products are highly rated. Ranking and scoring systems are associated with each financial product type, including bank accounts, credit cards, mortgages, home insurance, auto insurance, and other similar financial products.

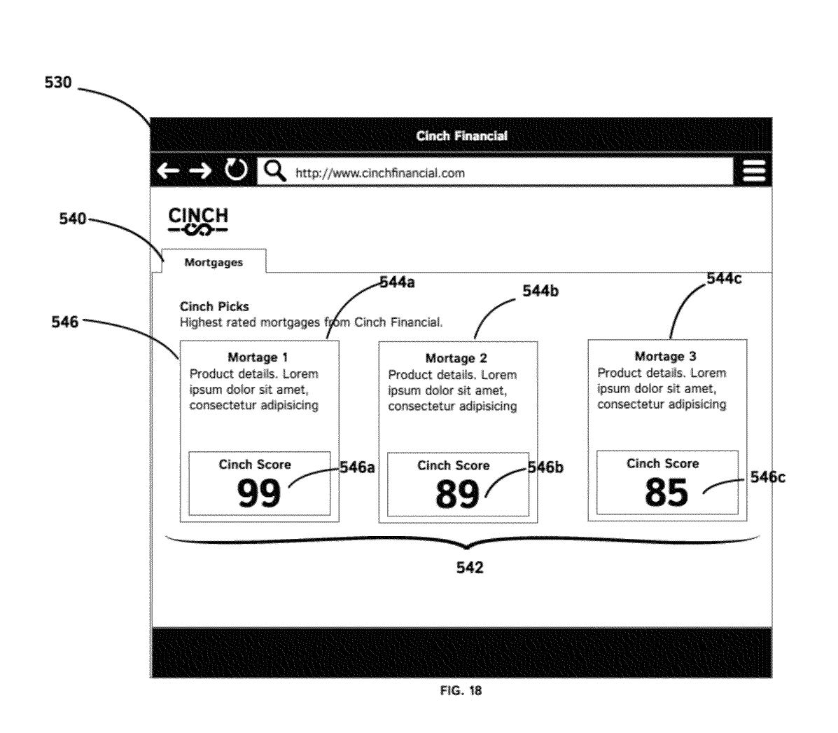

Referring to FIG. 18, GUI 530 displays a consumer view of highly ranked mortgages, e.g., mortgages with proprietary scores that exceed a threshold value and/or a predefined number of mortgages that are associated with the highest propriety score, relative to proprietary scores of other mortgages. GUI 530 includes product section 540 for display for highly ranked products (e.g., mortgages). Product section 540 includes proprietary picks section 542 for displays of the highest rated mortgages from the ranking and scoring process shown in FIG. 17.

Proprietary picks section 542 includes product information 544a, 544b, 544c. Using product information 544a, 544b, 544c, consumers can view multiple mortgages with details for each mortgage to allow side-by-side comparison. Details include the name of the mortgage provider, details about the mortgage terms, and the proprietary scores 546a-546c, as determined by the scoring and ranking process described in FIG. 17. FIG. 18 shows this arrangement for showing highly ranked mortgages, but this view would also be available for other financial products such as bank accounts, credit cards, mortgages, home insurance, auto insurance, and other similar financial products

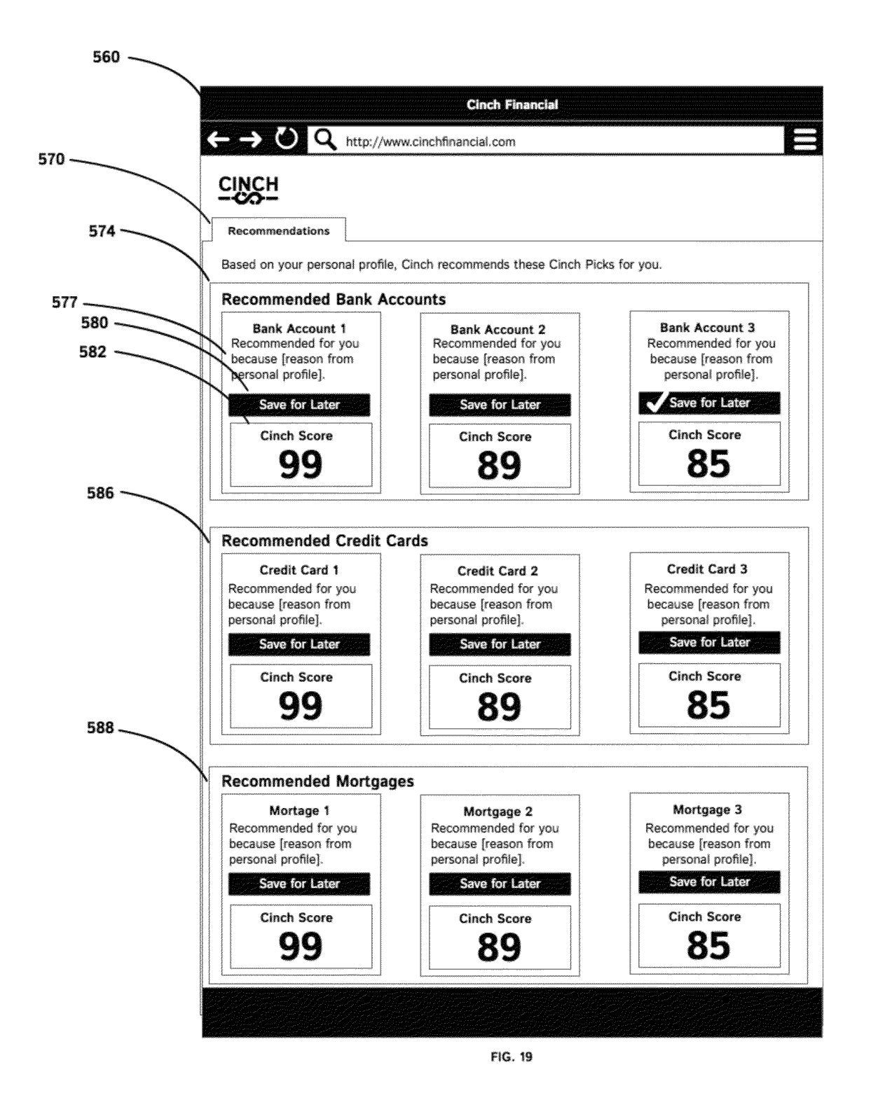

Referring to FIG. 19, GUI 560 displays tab 570 of a consumer view of highly ranked recommended financial products. These recommendations are created based on the information completed by the consumer in the personal profile described in FIGS. 13, 14, 15 and 16, and ranked and scored products described in FIG. 17. The consumer is shown recommended products in a bank account category 574, a credit card category 586, and a mortgage category 588. Categories for recommended products include bank accounts, credit cards, mortgages, home insurance, auto insurance, and other similar financial products. For recommended product information 578 that represents a particular recommended product, GUI 560 displays product names and details 577 and proprietary score information 582 that specifies the calculated proprietary score for the product. Consumers also have the ability to save a product to view later by selecting a save for later element 580 in the GUI 560. This would enable consumers to save multiple products to request pricing and to apply for the products. GUI 560 shows this arrangement for bank accounts, credit cards, and mortgages, but these recommendations are available for other financial products such as home insurance, auto insurance, and other similar financial products.

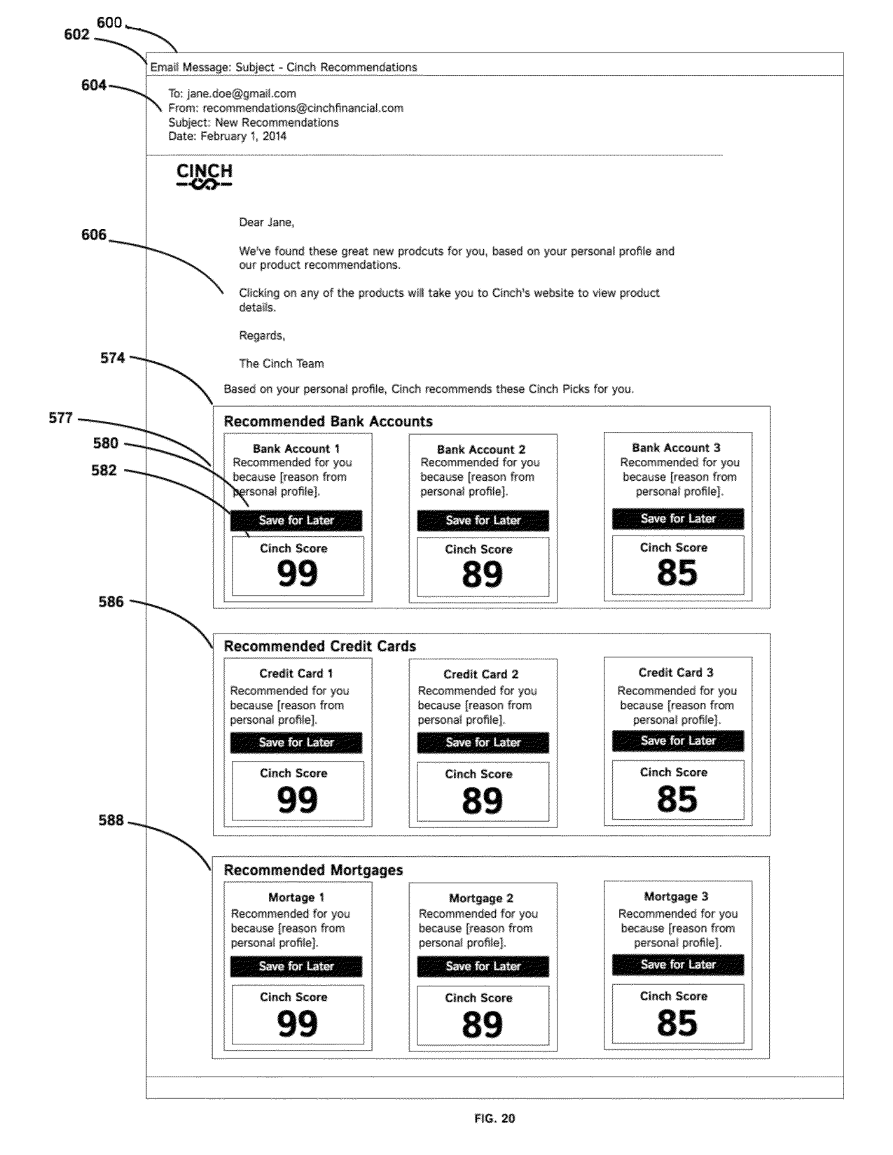

Referring to FIG. 20, GUI 600 displays a graphical representation 602 of a consumer email message (hereinafter “email message 602”). This email message 602 includes header information 604 communicates the consumer financial product recommendations described in FIG. 19. This message is sent when there were new recommendations to communicate to the consumer, or periodically, as set by the consumer. The email message 602 includes a message to the consumer 606 about the recommendations. These recommendations are generated based on the information completed by the consumer in the personal profile described in FIGS. 13, 14, 15 and 16 and matched with attributes of the ranked and scored products described in FIG. 17. A financial product is associated with various attributes, including, e.g., a price, a payment (a monthly payment), a product type, a geographic location, an income requirement to qualify for the product and so forth. The body of email message 602 includes contents from GUI 560 (FIG. 19). For example, the consumer is shown recommended products in each product category 574, 586, 588. Categories for recommended products include bank accounts, credit cards, mortgages, home insurance, auto insurance, and other similar financial products. This figure shows this arrangement for bank accounts, credit cards, and mortgages, but these recommendations are available for other financial products such as home insurance, auto insurance, and other similar financial products. Selecting any of these individual product recommendations would take the user to the consumer website or software application described in FIG. 19.

Referring to FIG. 21, GUI 610 shows a listing of financial products with have been saved for later by a consumer who has previously used this website or software application. GUI 610 includes saved for later tab 620 for display of products that were previously saved. In this example, saved for later tab 620 displays mortgage information 628, 629. In this example, saved mortgages are shown, but other products including bank accounts, credit cards, home insurance, auto insurance, and other similar financial products could also be included. For mortgage information 628, product name information and other details 630 are displayed, along with a proprietary score 634 for the product. Mortgage information 628 includes checkbox 631, selection of which specifies that the consumer requests payment quotes or prequalification information for the product represented by mortgage information. Mortgage information 629 includes checkbox 633, selection of which specifies that the consumer requests payment quotes or prequalification information for the product represented by mortgage information. GUI 610 includes graphical representation 636 for display of information specifying a number (if any) of products for which a user has requested (via selection of one or more of checkboxes 631, 633) to receive payment quotes or prequalifications. In this example, a user has not requested to receive payment quotes or prequalifications for any of the saved product information. Via control 638, consumers could choose to receive a pricing quote from a financial provider for the product. Via control 640, a consumer selects to apply for the product.

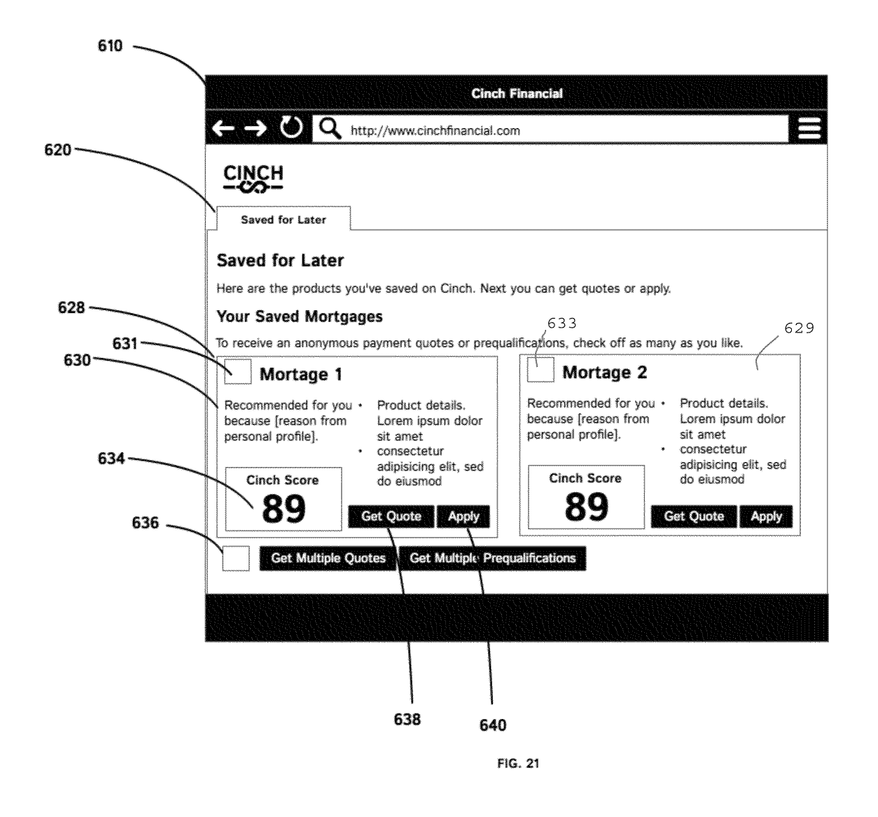

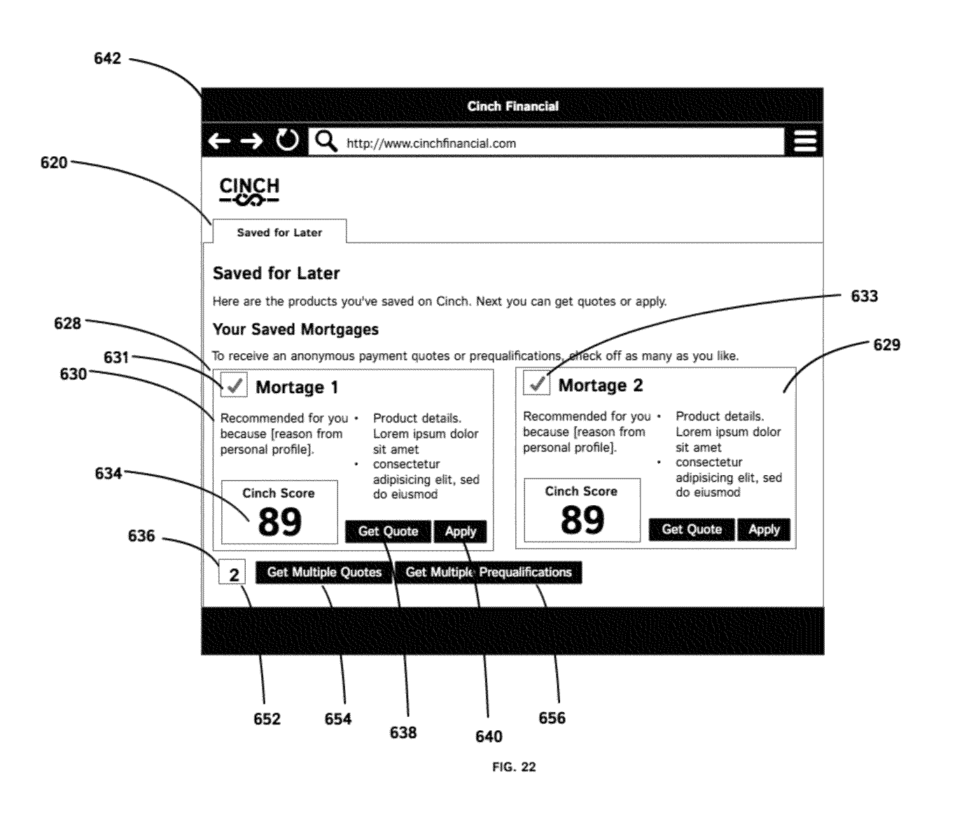

FIG. 22 shows GUI 642, which is an updated version of GUI 610. GUI 642 displays a listing of financial products, which have been saved for later by a consumer who has previously used a website or software application that displays GUI 642. In this example, the consumer selects checkboxes 631, 633. The number of checkboxes selected is tallied and information indicative of the tallied number is displayed in graphical representation 636. Selection of one or more of checkboxes 631, 633 enables the consumer to choose to receive pricing quotes from a financial providers and/or apply for multiple financial products by selecting the get multiple quotes button 654 and the get multiple prequalifications buttons 656. A prequalification includes an application for mortgages. GUI 641 shows saved mortgages information but this process would also be available for other financial products including bank accounts, credit cards, home insurance, auto insurance, and other similar financial products

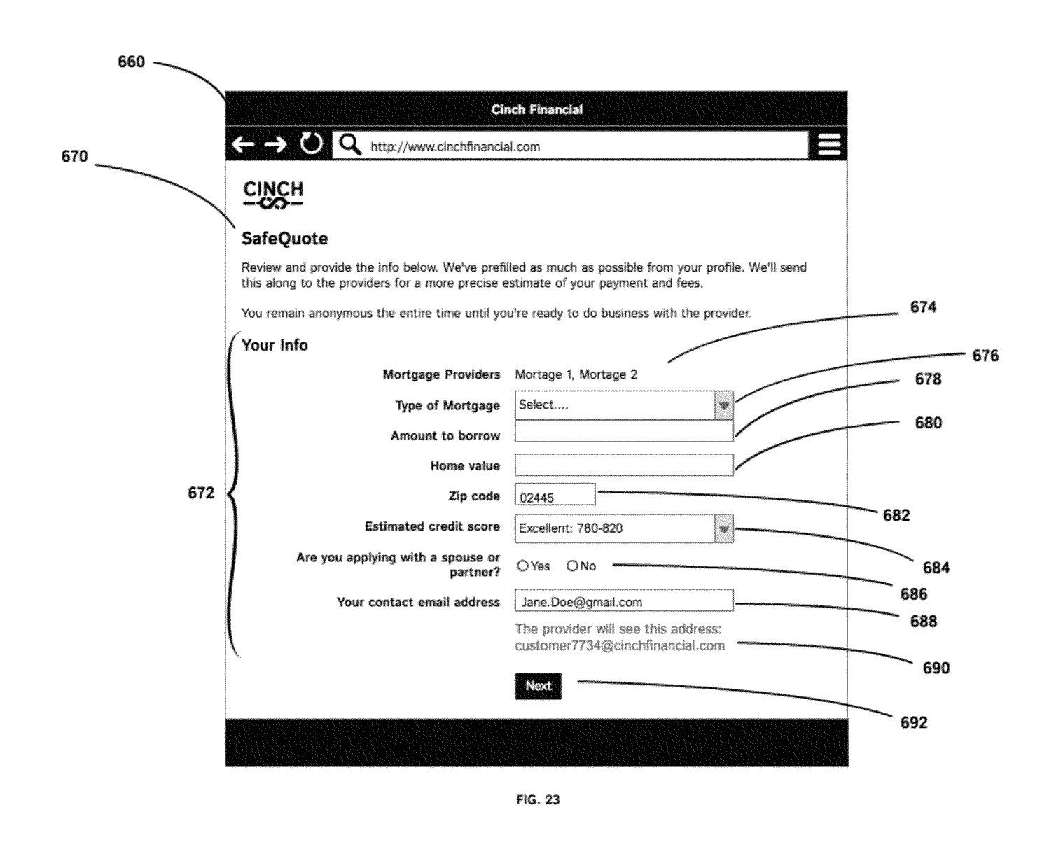

Referring to FIG. 23, GUI 660 is displayed in a consumer website or a software application. Through a process, a consumer initiates a request for a quote or an application to receive a financial product. This process includes single-source quote and application anonymous processing for multiple providers. GUI 660 includes section 670 that displays information describing a type of action (i.e., the process for applying or for receiving a quote) to be performed via GUI 660. To promote completion of the process, GUI 660 includes personal information section 672 with necessary data fields required for the particular financial product for which the consumer is requesting a price quote or applying, labeled your info 672. These fields would first be filled automatically for the consumer by using the consumer's data stored in the customer profile database 22. The consumer would then complete other fields if necessary. Some or all of this data could also be stored in the customer profile database 22. This example shows fields for a mortgage quote, but this process would also apply to products such as bank accounts, credit cards, home insurance, auto insurance, and other similar financial products, with the data fields changing for each product type. In this GUI 660, personal information section 672 includes field 674 for a consumer to indicate which product he/she is applying for, field 676 for the consumer to specify which products are of interest, field 678 to specify an amount in dollars the consumer wants to borrow, field 680 to specify the value of the home, field 682 to specify the consumer's zip code, field 684 for entry of the consumer's estimated credit score, control 686 for the consumer to specify whether or not the consumer is applying with a spouse or partner, and field 688 for the consumer to specify the consumer's email address. GUI 660 displays a temporary email address 690 that is generated by a system (e.g., the recommendation system), so that the consumer's actual email address remains private in this system. GUI 660 displays next control 692 for saving this entered data in the customer profile database 22, and for notifying the financial providers that the consumer has applied for their products.

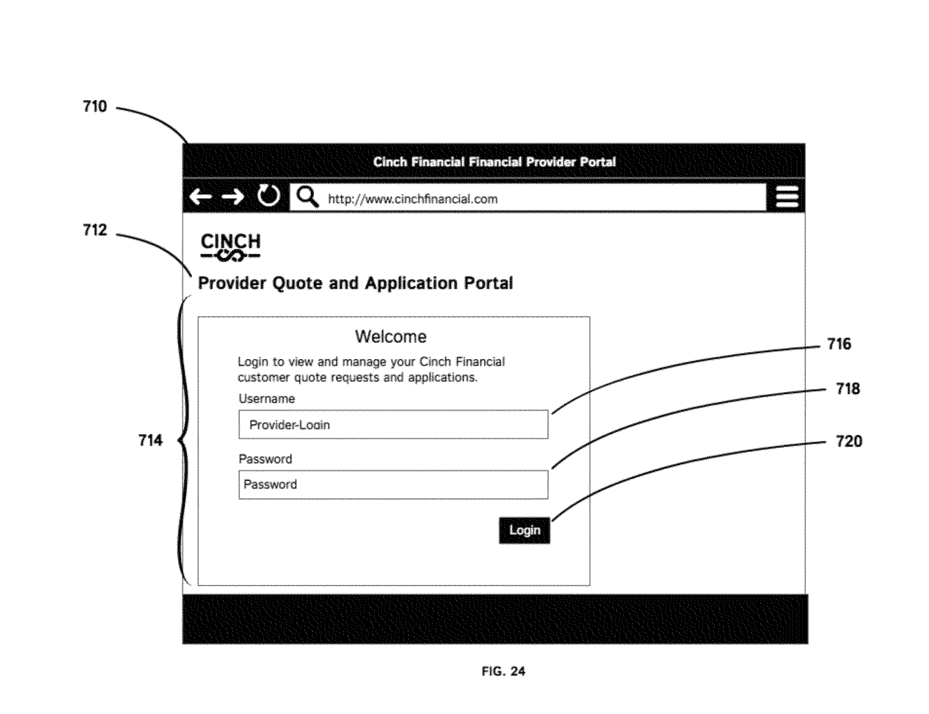

Referring to FIG. 24, GUI 710 is rendered through a website or software application for financial service providers. This website or software application would enable financial service providers to view, approve, deny, provide details, and communicate with consumers who have applied for price quotes and completed applications for the financial service provider's products. Products include bank accounts, credit cards, mortgages, home insurance, auto insurance, and other similar financial products. GUI 710 provides login section 714 that enables a service provider to log into a financial service provider portal. Each financial service provider are given a unique login identifier and password to log in and view consumer quote requests and completed applications for their products. Login section 714 includes fields 716, 718 for entry of username and password information, respectively. Selecting login control 720 would log the financial service provider into the portal.

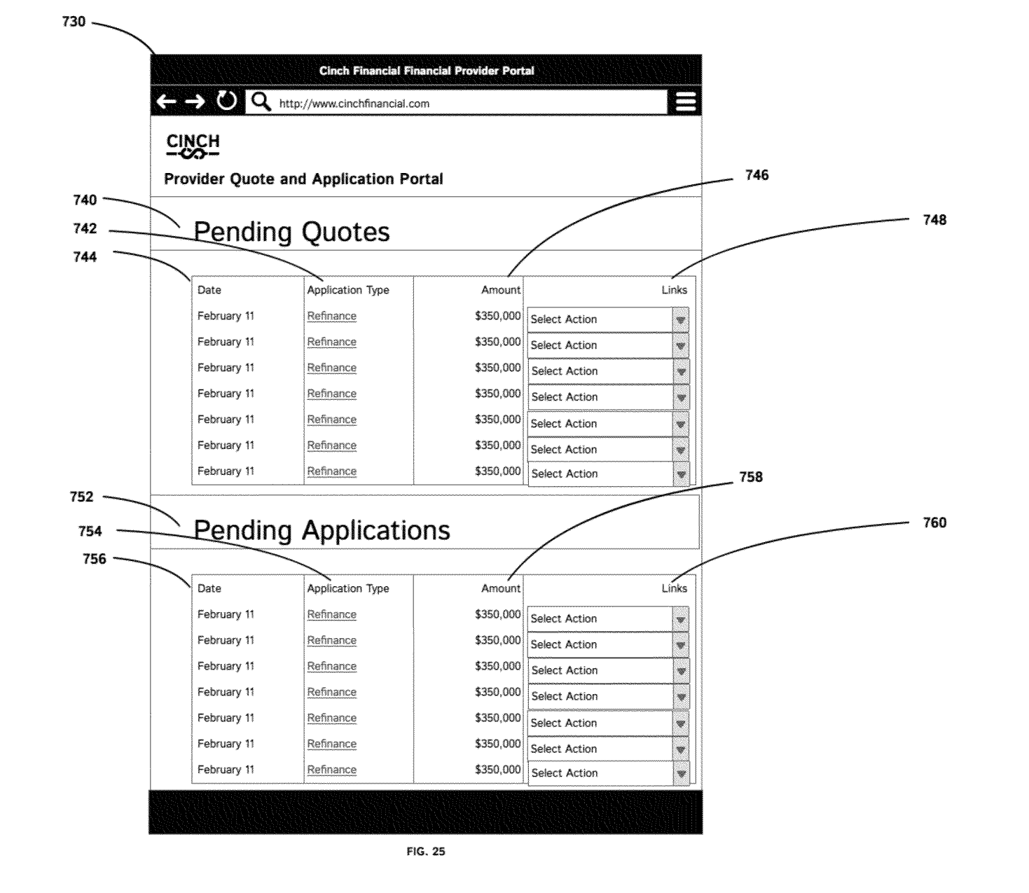

Referring to FIG. 25, GUI 730 is rendered by a website or software application for financial service providers. This website or software application enables financial service providers to view, approve, deny, provide details, and communicate with consumers who have initiated price quote requests and completed applications for the financial service provider's products. Products include bank accounts, credit cards, mortgages, home insurance, auto insurance, and other similar financial products. GUI 730 includes pending quotes section 740 and pending applications section 752 that lists quotes and/or applications by consumers for the products offered by the financial service provider who is using this website or software application. Pending quotes section 740 lists information indicative of quotes that have been sent to various consumers. Pending quotes section 740 includes summary information, such as dates of quote information 744, application type information 742, amounts applied for information 746 and links 748 for selection of other options, e.g., the ability to view details, approve or deny a quote or application, or communicate with the consumer who has applied.

Pending applications section 752 lists information indicative of applications for the financial service provider to review. Pending applications section 740 includes summary information, such as dates of quote information 756, application type information 754, amounts applied for information 758 and links 760 for selection of other options, e.g., the ability to view details, approve or deny a quote or application, or communicate with the consumer who has applied.

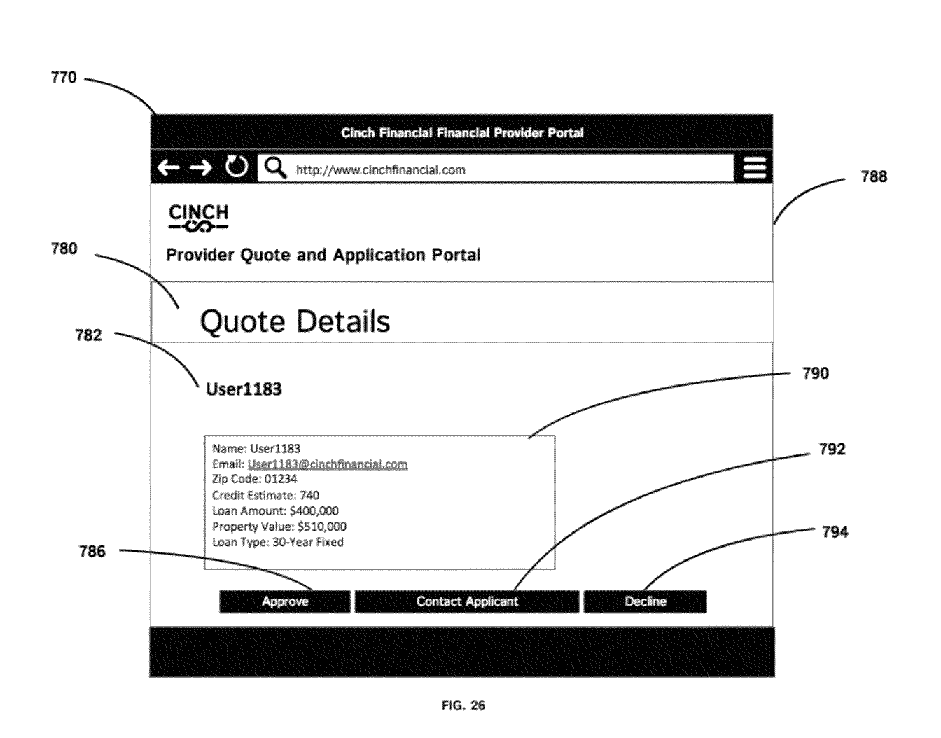

Referring to FIG. 26, GUI 770 is rendered by a website or software application for financial service provider employees. This website or software application would enable financial service providers to view, approve, deny, provide details, and communicate with consumers who have initiated price quotes requests and completed applications for the financial service provider's products. Products include bank accounts, credit cards, mortgages, home insurance, auto insurance, and other similar financial products. GUI 770 shows the details of a single consumer's request for a price quote or completed product application. GUI 770 includes details for a quote or application. In this example, GUI 770 includes quote details section 780 to display the details of a quotation, including, consumer user name information 782. The consumer's real name and/or contact information would not be revealed to financial service providers until the consumer approved doing so. Other details 790 include the anonymous email address, and other details necessary for the financial provider to approve or deny a consumer quote application or product application. A consumer's actual email address, phone number, and physical address would not be provided unless approved by the consumer. From here, a financial service provider could approve an application via approval control 786, contact the applicant via contact control 792, or decline the application via decline control 794. These actions would take place while keeping the real identity of the applicant anonymous. Although this example shows a mortgage pricing quote example, this process would also be developed for other financial products and processes, appropriate for giving price quotes and starting the application process for bank accounts, credit cards, mortgages, home insurance, auto insurance, and other similar financial products.

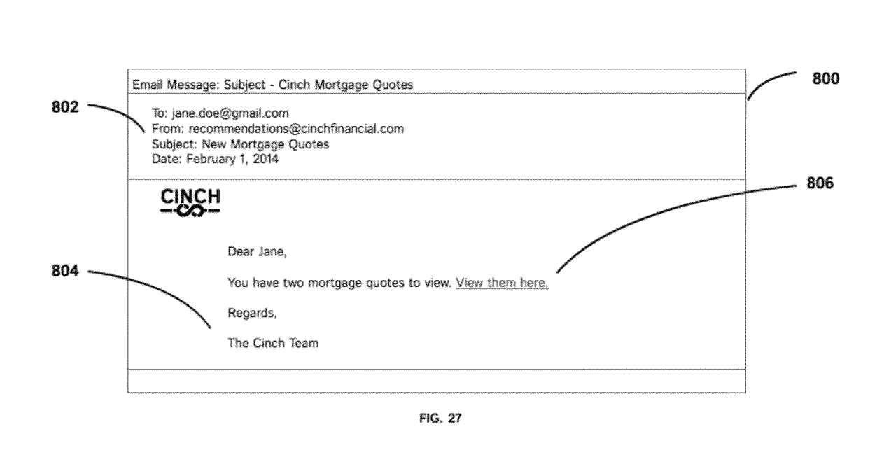

Referring to FIG. 27, GUI 800 displays a consumer email message. This email message communicates the status of a consumer quote request or application described in FIG. 26. This message is sent when a financial provider has completed a quote request or has processed a financial product application. The email message is sent to a consumer specified by recipient information 802. The email message includes link 806, selection of which enables a user to view the status of a quote request. Email message also include body portion 804 to display the contents of the email. Although this example shows a mortgage pricing example, this process would also be developed for other financial products and processes, appropriate for communications about price quotes and applications for bank accounts, credit cards, mortgages, home insurance, auto insurance, and other similar financial products.

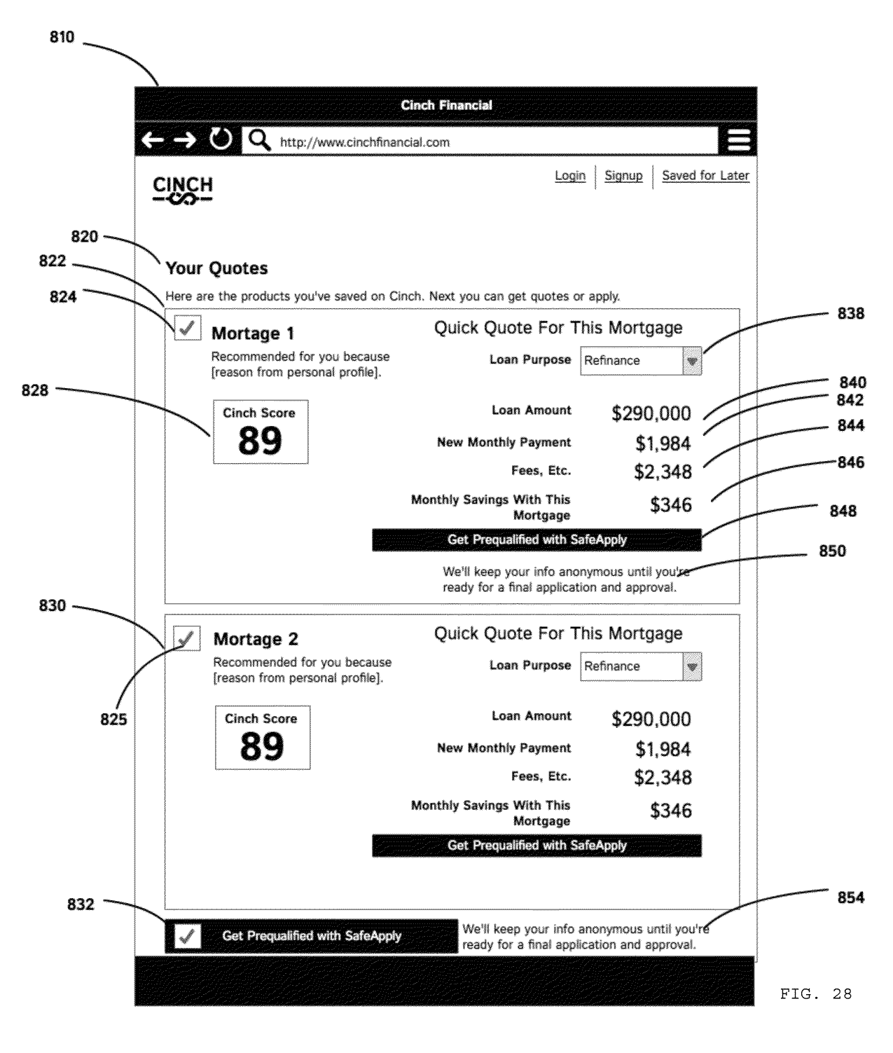

Referring to FIG. 28, GUI 810 is displayed in a consumer website or software application. GUI 810 shows the consumer the response from a financial service provider for a quote and financial product applications submitted by the consumer. The consumer could view multiple quote and application responses at once and in one simple format, versus responses from multiple providers, multiple formats, and multiple calculation methods. GUI 810 includes your quotes section 820 for display of information indicative of quotes that are provided to the viewer. Your quotes section 820 includes mortgage quote information 822, 830. Details for each quote shown here are examples, and actual quotes may show different data.

In this example, mortgage quote information 822 displays mortgage name and summary information 822, a proprietary score 828 (as computed from a scoring and ranking system), control 838 for selection of information specifying a purpose of the mortgage, the amount of the loan application information 840, information 842 specifying the monthly payment quoted by the financial product provider, information 844 specifying the fees quoted by the financial product provider, and information 846 specifying a calculated savings about for this product, which is the amount the consumer would save each month if the consumer replaced an existing product with this one.

Mortgage quote information 822, 830 includes checkboxes 824, 825, respectively, selection of which enables the user to specify the products for which the consumer request prequalification via button 832, e.g., in order to continue the process and apply for multiple financial products at once—independent of individually and separately filling out each application. Upon selection of button 832, the system provides single-source application anonymous processing for multiple providers by: accessing, from a data repository, personal profile information of the consumer, generating anonymous consumer information by removing, from the personal profile information, identifying information of the consumer, and transmitting to the providers the anonymous information for application processing. As specified by information 850, 854, the consumer's name, address, email and other personally identifiable information remains anonymous as part of this process. Although this example shows a mortgage quote process, this would also be the same process for pricing quotes and applications for other financial products, including bank accounts, credit cards, mortgages, home insurance, auto insurance, and other similar financial products. In another example, system 912 creates recommendations automatically by monitoring, e.g., at specified time intervals.

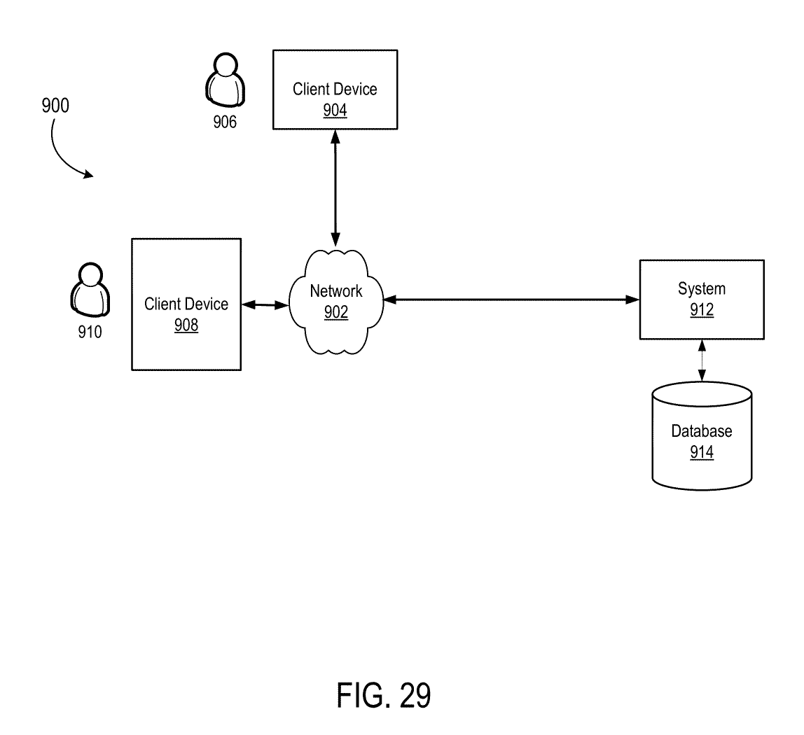

Referring to FIG. 29, networked environment 900 includes network 902, client devices 904, 908, system 912 and data repository 914. In this example, client device 904 is associated with a user who is a financial service provider 906. For example, financial service provider 906 uses client device 904 to access the financial service provider portal and to view applications. Client device 908 is associated with user 910, e.g., a consumer. In this example, user 910 uses client device 908 to view recommendations of financial products that are specific to the consumer, to request quotations of financial products, to view quotations of financial products, to request applications for financial products, to view applications for financial products, to apply for financial products, and so forth.

System 912 is a system for generating recommendations of financial products and for implementing the techniques and operations described herein. For example, system 912 includes the various systems described herein, e.g., financial product curation and scoring system 70, the recommendation system 126 and other systems described herein. The various systems included in system 912 may be implemented as an engine. For example, recommendation system 126 maybe be implemented as a recommendation engine within system 912. In this example, system 912 generates the provider portal and transmits information to client device 904 to promote approval of application requests and quotations. System 912 also transmits to client device 908 various types of information, including, e.g., information indicative of a recommended financial product, a score (e.g., a proprietary score) for the financial product, approval of various financial products, specialized offers for financial products, and so forth.

Database 914 includes the various databases that are described herein, including, e.g., customer profile database 22, curated and scored financial product information database 82, and so forth. In an example, the contents of customer profile database 22 and curated and scored financial product information database 82 are integrated into a single database and are included in database 914.

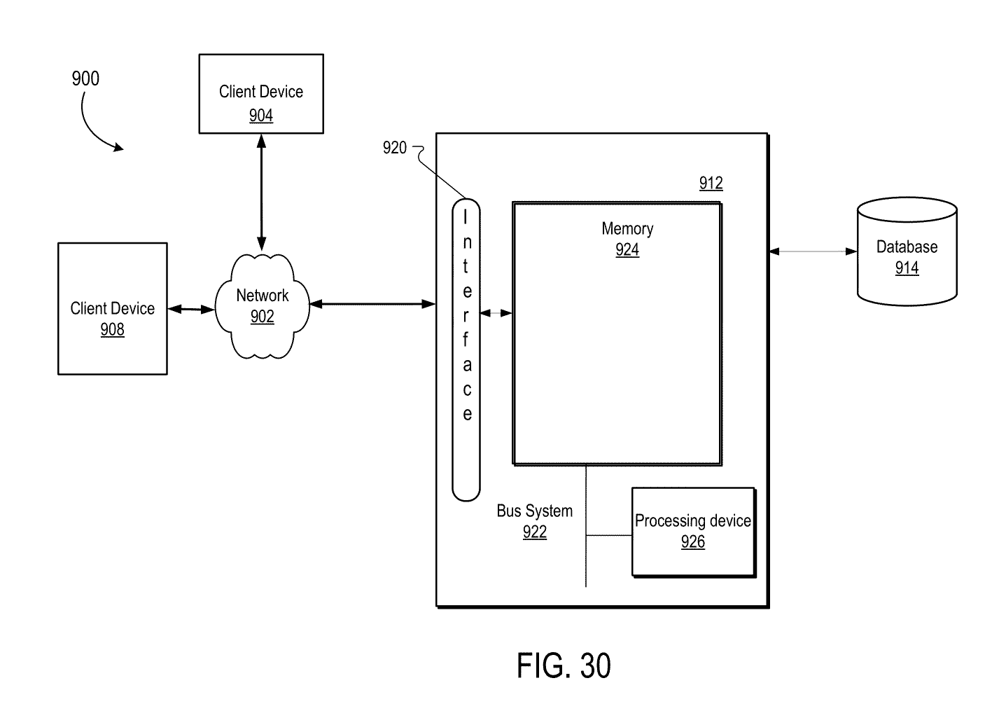

Referring to FIG. 30, client devices 904, 908 can be any sort of computing devices capable of taking input from a user and communicating over network 902 with system 912 and/or with other client devices. For example, client devices 904, 908 can be mobile devices, desktop computers, laptops, cell phones, personal digital assistants (“PDAs”), iPhone, smart phones, iPads, servers, embedded computing systems, and so forth.

System 912 can be any of a variety of computing devices capable of receiving data, such as a server, a distributed computing system, a desktop computer, a laptop, a cell phone, a rack-mounted server, and so forth. System 912 may be a single server or a group of servers that are at a same location or at different locations. The illustrated system 912 can receive data from client devices 904, 908 via input/output (“I/O”) interface 920. I/O interface 920 can be any type of interface capable of receiving data over a network, such as an Ethernet interface, a wireless networking interface, a fiber-optic networking interface, a modem, and so forth.

System 912 includes memory 924, a bus system 922, and a processing device 926. Memory 924 can include a hard drive and a random access memory storage device, such as a dynamic random access memory, machine-readable media, or other types of non-transitory machine-readable storage devices. A bus system 922, including, for example, a data bus and a motherboard, can be used to establish and to control data communication between the components of system 912. Processing device 926 may include one or more microprocessors and/or processing devices. Generally, processing device 926 may include any appropriate processor and/or logic that is capable of receiving and storing data, and of communicating over a network (not shown).

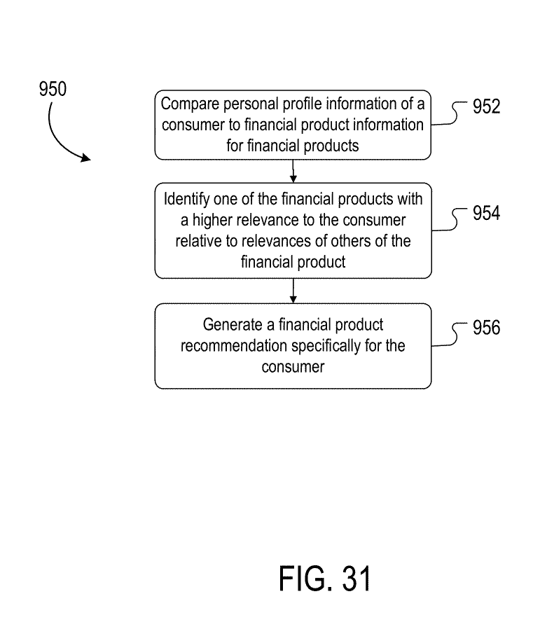

Referring to FIG. 31, system 912 implements process 950 in recommending a financial product to a consumer. In operation, system 912 compares (952) personal profile information of a consumer to financial product information for financial products. The personal profile information includes information indicative of one or more preferences of the consumer, e.g., pricing preferences that specify a desired price of the financial product, payment preferences that specify an amount of a monthly payment the consumer can afford, geographic preferences that specify a desired geographic location of a financial service provider, and so forth. The financial product information includes information indicative of attributes of the financial products, e.g., a price attribute, a payment amount attribute, a geographic location attribute, and so forth.

System 912 identifies (954), based on the comparing, one of the financial products with a higher relevance to the consumer relative to relevances of others of the financial products. In an example, relevance is measured by a number of matched between preferences and attributes. System 912 also generates (956), based on the identified financial product, a financial product recommendation specifically for the consumer.

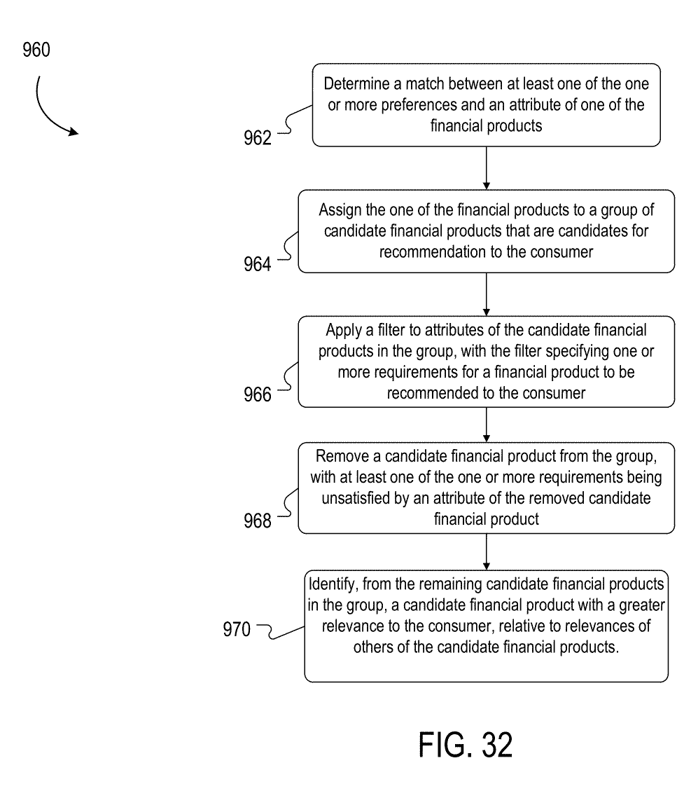

Referring to FIG. 32, system 912 implements process 960 in generating a recommendation for a financial product. In operation, system 912 determines (962) a match between at least one of the one or more preferences and an attribute of one of the financial products. System 912 assigns (964) the one of the financial products to a group of candidate financial products that are candidates for recommendation to the consumer. System 912 also applies (966) a filter to attributes of the candidate financial products in the group, with the filter specifying one or more requirements for a financial product to be recommended to the consumer. System 912 removes (968), based on application of the filter, a candidate financial product from the group, with at least one of the one or more requirements being unsatisfied by an attribute of the removed candidate financial product. System 912 identifies (970), from the remaining candidate financial products in the group, a candidate financial product with a greater relevance to the consumer, relative to relevances of others of the candidate financial products.

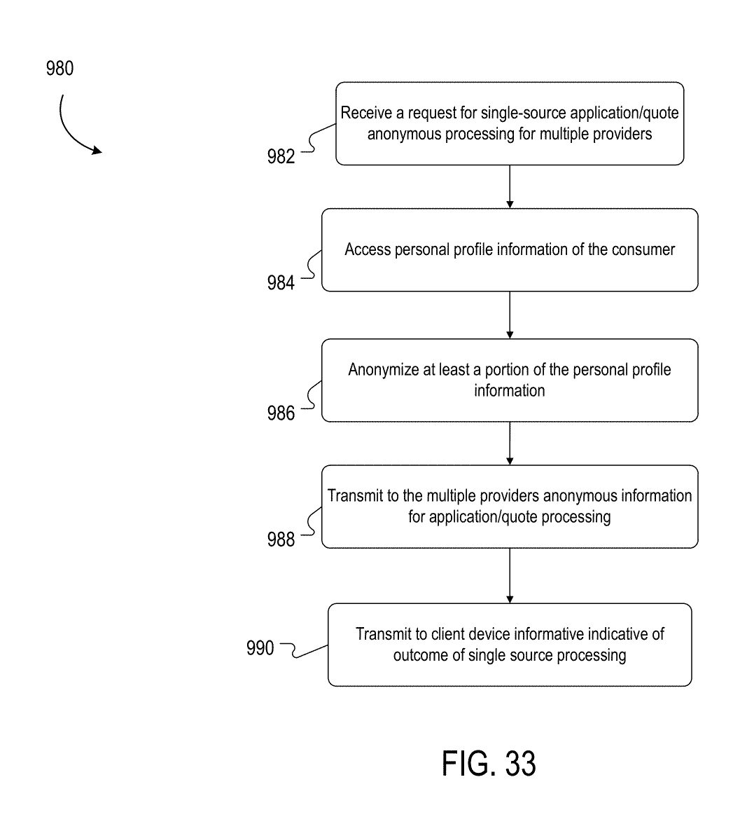

Referring to FIG. 33, system 912 implements process 980 in performing single-source application and/or anonymous processing for multiple service providers. In operation, system 912 receives (982) a request for single-source application/quote anonymous processing for multiple providers. In response to the request, system 912 accesses (984), from a database 914, personal profile information of the consumer. System 912 anonymizes (986) at least a portion of the personal profile information by removing, from the personal profile information, identifying information of the consumer. System 912 transmits (988) to the providers the anonymous information for application and/or quote processing. In response, system 912 receives (not shown), from devices associated with the multiple providers, information indicative of results of the application and/or quotation processing. Using this received information, system 912 transmits (990), to a client device of the consumer, information indicative of an outcome of the single source processing. In an example where the single source processing is single source application processing, the outcome includes an outcome of the application processing, e.g., approval and/or denial of the application. In an example where the single source processing is single source quotation processing, the outcome includes an outcome of the quotation processing, e.g., price quotes for various financial products of the financial service providers.

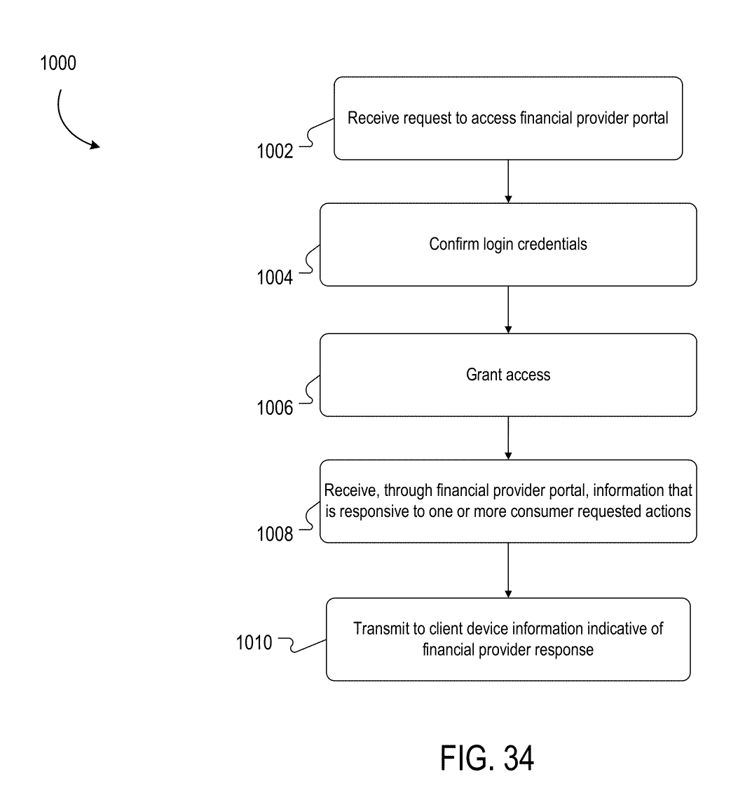

Referring to FIG. 34, system 912 performs process 1000 in enabling a financial service provider to interact with a provider portal. In operation, system 912 receives (1002), from a client device (e.g., client device 904), a request to access a financial provider portal. The request includes login credentials, e.g., a user name and a password. Using the received login credentials, system 912 confirms (1004) that the financial service provider is authorized to access the portal. In response to confirming, system 912 grants (1006) the service providers with access to the portal and with access to information within the portal that the service provider is authorized to view (e.g., applications for products of the service provider).

In this example, system 912 receives (1008), through the financial provider portal and from the financial service provider, information that is responsive to one or more consumer related requests. The responsive information may include information indicative of approval or denial of an application, information representing a price quotation, and so forth. System 912 transmits (1010), to a client device (e.g., client device 908) information indicative of the response.

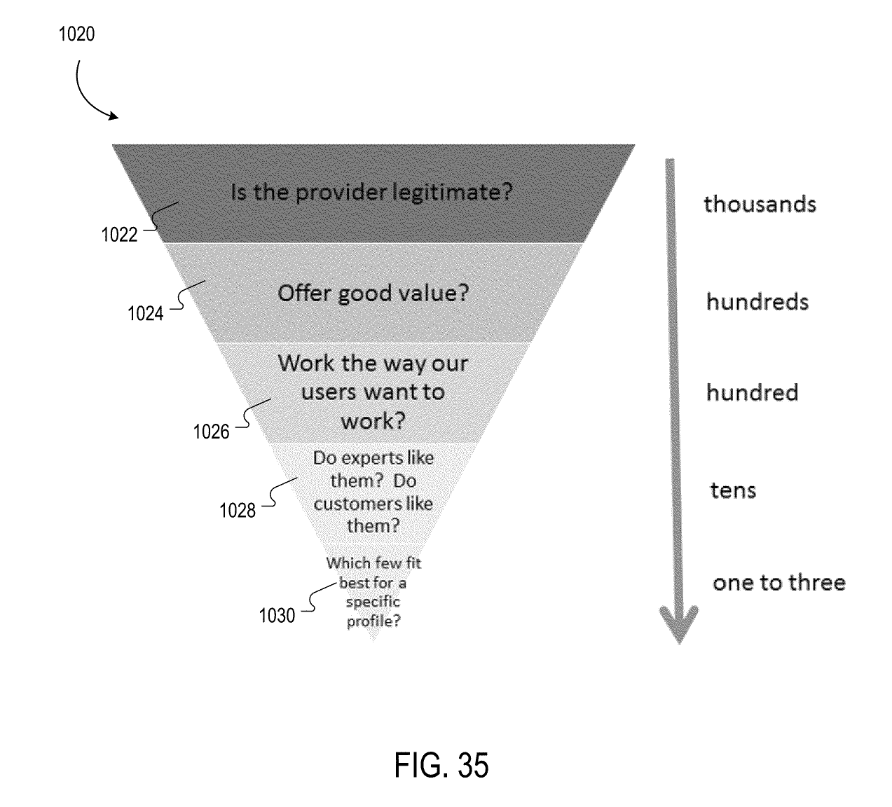

Referring to FIG. 35, system 912 implements process 1020 in curating financial products. Through a curation process, financial products are narrowed from thousands of financial products (e.g., by assessing whether a financial service provider is legitimate) to a few financial products. If system 912 determines that a financial service provider is not legitimate, then system 912 ceases evaluation of that service provider. As shown in FIG. 35, system 912 curates financial products by evaluating the financial product and/or provider along criteria 1022-1030. If a financial product and/or provider fails to satisfy one of the criteria, system 912 cease the curation process for that product.

In an example, system 912 implements a series of operations for the curation process, as shown in the below Table 1.

TABLE 1

| Se- | | | Funnel (number |
|---|---|---|---|
| quence | Steps | Data Sources | of providers) |
| Step 0 | Define the specific mort- | MBA | 1000+ |
| | gage options available | | |
| Step 1 | Secure the entire universe | MBA | 300+ |
| | of mortgages available | | |
| Step 2 | Screen for legitimate | MBA | 50+ |
| | providers | | |
| Step 3 | Screen for geographic | MBA data (down to | 40+ |
| | location | the county level) | |
| Step 4 | Score for pricing/value | Company Websites/ | 10-20 |
| | | Mystery Shopping | |
| Step 5 | Score application and | Company Websites/ | 5-15 |
| | closing process | Mystery Shopping/ | |
| | | MBA data | |
| Step 6 | Score reputation attrib- | Mystery Shopping, | 5-15 |
| | utes of provider | Social Media, CFPB, | |
| | | BBB, FI sites | |
| Step 7 | Calculate the total Cinch | Cinch Scores | 5-10 |
| | score to determine Cinch | | |
| | Picks | | |
| Step 8 | Screen in for exceptions | Cinch Research | 5+ |
| | missed in the data and/or | | |
| | computation | | |
| Step 9 | Build links to Cinch | Company Websites/ | 1-3 |
| | formulas to calculate | Mystery Shopping | |
| | customer specific pricing | | |

As described in the above Table 1, system 912 implements steps 0-9 in curating financial products and providers. System 912 obtains data from various sources, including, e.g., mortgage banker's association (MBA). A shown above, the number of providers is narrowed or funneled from 1000+ providers to one or three providers, which are then scored. In this example, system 912 evaluates a financial provider based on the criteria specified in the various steps. For example, the scoring of the closing process is performed by system 912 through analysis of the closing attributes shown in the below Table 3. System 912 also evaluates other of the curation policies shown in Tables 1, 2 based on the attributes shown in the below Table 3.

As shown in the below Table 2, system 912 implements various curation screening and scoring policies for a financial product, e.g., a mortgage.

TABLE 2

| Curation Step | Policy |
|---|---|
| Product Segments | 2 Products by Transaction type: Purchase and |
| | Refinance |
| Product Segments | 3 Products by Transaction amount: Conforming, |
| | Jumbo, FHA |
| Product Segments | 3 Products by Product type: 30 yr. fixed, 15 yr. fixed, |
| | 5/1 ARM |
| Providers | Provider score will be unique by state due to value |
| | differences at the state level |
| Providers | Must right in the covered DMA's |
| Weighting Scores | weight each segment equally |
| Weighting Scores | attributes weighted based on relative importance |
| Weighting Scores | Attributes where sentiment can't be derived receive |
| | a score of 75 |
| Legitimacy | Scale at least 50 bps market share |
| Legitimacy | Close Rate above average |
| Legitimacy | Denial Rate above average |
| Legitimacy | Exclude correspondent and broker, i.e. focus only |
| | on retail lenders |
| Geographic | Per research and if unknown assume county of |
| Coverage | incorporation for local providers |
| Value | Assume <80% LTV and adjust with fit score and |
| | screens for providers that don't serve low DP |
| | consumers |
| Value | Assume good credit (720) and adjust fit score |
| | accordingly for lower credit |
| Value | Use average loan amounts for conforming and jumbo |
| | to calculate fees and expected pricing for score— |
| | $201,000 and $75,000 |
| Value | Cinch includes lender and third party fees—they have |
| | the same impact on the consumer |
| Value | Compare 0% or lowest point mortgages for each |
| | provider |
| Value | Include cost of points if applicable as a component |
| | of the fee |
| Value | Include all provider and third party fees |
| Value | Amortize fees over a 5 year time horizon to match |
| | average mortgage duration |

As shown in the above Table 2, system 912 curates (e.g., categories) the various products by various critiera, e.g., product segments, providers, weighting scores, legitimacy, geographic coverage and value. For example, system 912 groups into a product segment various types of products, e.g., products with a similar transaction amount or products with a denial rate about average, and so forth. That is, system 912 analyzes the attributes of the various financial products and curates them into various group based on similiarities among the products. These curations are then used in answering the questions as shown in the above Table 1. In this example, the curations promote categorization of the various financial product and assist system 912 in answering the questions shown in the above Table 1.

As shown in the above Table 2, system 912 determines values based on various policies. In this example, if a financial product fails to satisfy one of the value policies, system 912 determines that the financial product is not a good value. System 912 performs similar operations for the other curation policies.

As shown in the below Table 3, system 912 implements the below shown scoring rubic, which is stored in a data repository.

TABLE 3
Mortgage Scoring Rubric

| | | | Weight | |
|---|---|---|---|---|
| | Value | | 25% | |
| | Application | | 25% | |
| | Closing | | 25% | |
| | Reputation | | 25% | |
| | | | Attribute | Data Source |
| Segment | Attribute | Weight | Type | |
| Applica- | Easy to get started | 30% | Company | Cinch research |
| tion | online with a simple | | | |
| | website | | | |
| | Easy to get started over | 20% | Company | Cinch research/ |
| | the phone | | | mystery shopping |
| | Simple application | 20% | Company | Cinch research |
| | form and documenta- | | | |
| | tion checklist | | | |
| | Dedicated point of | 15% | Company | Cinch research/ |
| | contact (phone/email) | | | mystery shopping |
| | Local Branches or | 15% | Company | Cinch research |
| | offices | | | |
| Closing | Close Rate | 50% | Segment | MBA data |
| | Closing costs are easy | 20% | Company | Cinch research/ |
| | to understand, | | | mystery shopping |
| | transparent and | | | |
| | competitive | | | |
| | Offers multiple closing | 20% | Company | Cinch research/ |
| | cost and point options | | | mystery shopping |
| | Denial Rate | 20% | Segment | MBA data |
| | Percentage of loan | 10% | Segment | MBA data |
| | assets retained | | | |
| Reputa- | Customer churn trend | 40% | Company | MBA data |
| tion | Social Media Profile | 40% | Company | Cinch Research |
| | JD Power | 10% | Company | Cinch Research |
| | CFPB | 10% | Company | JD Power and |
| | | | | CFPB data |
| Value | Pricing-Interest Rate | 60% | Product | Cinch research/ |
| | | | | mystery shopping |
| | Lender Closing Costs | 30% | Product | Cinch research/ |
| | | | | mystery shopping |
| | 3rd Party Closing Costs | 10% | Product | Cinch research/ |
| | | | | mystery shopping |

As shown in the above Table 3, system 912 generates a score for a financial product by evaluating the financial product in four segments, e.g., an application segment, a closing segment, a reputation segment and a value segment. In calculating the final score, system 912 assigns weight to each of the segments, as shown in Table 3. Additionally, system 912 evaluates each segment by various attributes and individually weights each attribute within a segment. For example, system 912 evaluates the application among various attributes, including, e.g., an “easy to get started online with a simply website” attribute and other attributes as shown in Table 3. Each attribute is associated with an attribute type, e.g, company, segment, product. There are various data sources for an attribute, including, e.g., internal research (i.e., Cinch research) and external data sources, including, e.g., MBA data. In this example, system 912 only generates scores for particular financial products, e.g., financial products that pass one or more of the criteria of the curation process.

As shown in the below Table 4, each attribute is associated with a score range and requirement.

TABLE 4

| Segment | Attribute | Weight | Score Range | Requirement |
|---|---|---|---|---|
| Reputation | Customer churn trend | 0.4 | 95 | Increasing market share |
| | | | 75 | Flat YOY |
| | | | 50 | Decreasing Market Share |
| | Social Media Profile | 0.4 | 95 | Strong positive |
| | | | 75 | Average/No sentiment |
| | | | 50 | Strong Negative sentiment |
| | JD Power | 0.1 | 95 | Best in class |
| | | | 85 | above average |
| | | | 75 | average/not covered |
| | | | 50 | below average |
| | CFPB | 0.1 | 95 | top 5 proyider by complaints |
| | | | 85 | above average |
| | | | 75 | average/not included |
| | | | 50 | below average |
| Application | Easy to get started online | 0.3 | 95+ | Mortgage rate estimator, easy to navigate website, prequalification, |
| | with a simple website | | | pre-approval options, easily evaluate loan and closing cost option |
| | | | 85 | Mortgage Rate estimator, pre-qualification, pre-approval options, |
| | | | | explanation of the process, evaluate different loan options |
| | | | 75 | Mortgage rate estimator, online pre-approval, explanation |
| | | | | of the process |
| | | | 60 | Online application, easy to find contact number |
| | | | 50 | Online application |
| | | | 40 | Contact us only-no online engagement |
| | Easy to get started over the | 0.2 | 95 | Direct to mortgage loan officer |
| | phone | | 75 | IVR leading to mortage loan officer |
| | | | 50 | IVR leading to inbound customer support queue |
| | Simple application form and | 0.2 | 95+ | Online/Mobile App that allows for transfer of documents |
| | documentation checklist | | 85 | Easy to understand checklist that users can print out to prep for |
| | | | | the application process |
| | | | 75 | Webpage with list that isn't in a checklist format |
| | Dedicated point of contact | 0.15 | 85 | Dedicated Contact |
| | (phone/email) | | 65 | Serviced by multi member team |
| | Local Branches or offices | 0.15 | 95 | Branches throughout state |
| | | | 80 | Branches in major metro areas |
| | | | 50 | No Branches in the state |
| Closing Process | Close Rate | 0.3 | 95 | top 5 providers |
| | | | 85 | providers 6-15 |
| | | | 75 | providers 15+ |
| | Closing Costs are easy to | 0.2 | 95+ | Lists all the lender and 3rd party fees |
| | understand, transparent | | 80 | Lists all the lender fees and some of the 3rd party fees |
| | and competitive | | 60 | Lists the lender fees |
| | | | 50 | Lists no fees |
| | Offers multiple closing cost | 0.2 | 95+ | Includes No Points/No Closing cost options in addition to |
| | and point options | | | other combinations |
| | | | 85 | Multiple options for paying or not paying points with increasing |
| | | | | credits for different rate tiers |
| | | | 50 | Includes manditory origination fee even if points are eliminated |
| | Denial Rate | 0.2 | 95 | top 5 provider |
| | | | 85 | providers 6-15 |
| | | | 75 | providers 15+ |
| | Percentage of loan assets | 0.1 | 100 | 100% retention |
| | retained | | 85 | 80%+ |
| | | | 75 | 50%-80% |
| | | | 65 | <50% |
| Value | Pricing-Interest Rate | 0.6 | 0-100 | Forced Rank within the competitive set |
| | Lender Closing Costs | 0.3 | 0-100 | Forced Rank within the competitive set |
| | 3rd Party Closing Costs | 0.1 | 0-100 | Forced Rank within the competitive set |

Total Score

As shown in the above Table 4, for the reputation segment, system 912 determines whether a service provider has an increasing market share (in which case the service provider is assiging a 95 for score range), and so forth. In this example, system 912 determines a reputation score (e.g., a weighted reputatoin score) for each reputation attribute, in accordance with the below formula:

Reputation score=(w₁)(customer churn trend score)+(w₂)(social media profile score)+(w₃)(JDPower score)+(w₄)(CFPB score), where w is a weighted value.

System 912 uses similar techniques in computing a value score, a closing process score and an application score. System 912 then calculates a propriety score in accorance with the below equation:

Proprietary score=(w₁)(reputation score)+(w₂)(value score)+(w₃)(closing process score)+(w₄)(application score), where w is a weighted value.

As shown above, the proprietary score is based on an aggregate of a reputation score, a value score, a closing process score and an application score. In other implementations, the proprietary score is based on application one or more various mathematical operations to a reputation score, a value score, a closing process score and an application score. Also, in this example, the proprietary score is based on a reputation score, a value score, a closing process score and an application score. In other examples, the proprietary score is based on other types of scores that are based on other types of criteria, segments and attributes.

As shown in the below Table 5, once a score (e.g., a proprietary score) is calculated, system 912 uses the data in the below Table 5 to evaluate the financial product, e.g., relative to other financial products.

TABLE 5
Scoring Criteria

| | |
|---|---|
| 90-100 | In the top 10 |
| 80-90 | Better than average |
| 70-80 | Average |
| 60-70 | Below Average |
| <60 | In the bottom quartile |

Segments weighted equally
Attributes within each segment weighted by relative importance

For example, a score 90-100 indicates that the financial product is in the top 10.

Embodiments can be implemented in digital electronic circuitry, or in computer hardware, firmware, software, or in combinations thereof. Apparatus of the invention can be implemented in a computer program product tangibly embodied or stored in a machine-readable storage device for execution by a programmable processor; and method actions can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

Other embodiments are within the scope and spirit of the description claims.

Additionally, due to the nature of software, functions described above can be implemented using software, hardware, firmware, hardwiring, or combinations of any of these. Features implementing functions may also be physically located at various positions, including being distributed such that portions of functions are implemented at different physical locations. The use of the term “a” herein and throughout is not used in a limiting manner and therefore is not meant to exclude a multiple meaning or a “one or more” meaning for the term “a.”

A number of embodiments have been described. Nevertheless, it will be understood that various modifications may be made without departing from the spirit and scope of the techniques described herein.

What is claimed is:

1. A computer-implemented method comprising:
comparing, by one or more computer systems, personal profile information of a consumer to financial product information for financial products;
identifying, based on the comparing, one of the financial products with a higher relevance to the consumer relative to relevances of others of the financial products; and
generating, based on the identified financial product, a financial product recommendation specifically for the consumer.

2. The computer-implemented method of claim 1, further comprising:
generating a score for the identified financial product, the score being indicative of an assessed valuation of the financial product, and the score being based on evaluation of the identified financial product across a plurality of variables.

3. The computer-implemented method of claim 2, further comprising:
retrieving information indicative of scores that are assigned to the plurality of variables;
wherein generating the score comprises:
generating the score based on the assigned scores.

4. The computer-implemented method of claim 2, further comprising:
generating information for a graphical user interface that when presented on a client device displays:
a first graphical representation of the financial product recommendation specifically for the consumer; and
a second graphical representation of the score for the identified financial product that is included in financial product recommendation specifically for the consumer;
wherein the first graphical representation is juxtaposed to the second graphical representation in the graphical user interface.

5. The computer-implemented method of claim 1, wherein the personal profile information comprises information indicative of one or more preferences of the consumer, and wherein the financial product information comprises information indicative of attributes of the financial products, and wherein the method further comprises:
determining a match between at least one of the one or more preferences and an attribute of one of the financial products; and
assigning the one of the financial products to a group of candidate financial products that are candidates for recommendation to the consumer.

6. The computer-implemented method of claim 5, further comprising:
applying a filter to attributes of the candidate financial products in the group, with the filter specifying one or more requirements for a financial product to be recommended to the consumer; and
removing, based on application of the filter, a candidate financial product from the group, with at least one of the one or more requirements being unsatisfied by an attribute of the removed candidate financial product;
wherein identifying the financial product with the greater relevance to the consumer comprises:
identifying, from the remaining candidate financial products in the group, a candidate financial product with a greater relevance to the consumer, relative to relevances of others of the candidate financial products.

7. The computer-implemented method of claim 6, wherein the candidate financial product with the increased amount of relevance to the consumer is a particular financial product, among the remaining candidate financial products, with a highest amount of matches between attributes of the particular financial product and the one or more preferences of the consumer.

8. The computer-implemented method of claim 6, wherein the one or more preferences of the consumer comprise a pricing preference for a financial product, wherein an attribute comprises a price, and wherein the filter comprises a personalized pricing filter that eliminates products based on the pricing preference of the consumer, and wherein the method further comprises:
determining a mismatch between the pricing preference and a price of the candidate financial product that is removed.

9. The computer-implemented method of claim 1, further comprising:
receiving, from a client device associated with the consumer, a request for an application for the identified financial product, with the identified financial product being included in the financial product recommendation specifically for the consumer;
causing information indicative of the requested application to be transmitted to the client device;
receiving, from the client device, a completed version of the requested application;
granting access to the completed version of the requested application to a financial service provider that provides a financial product that is applied for by the application; and
notifying the financial service provider that the completed version of the requested application is available for review.

10. The computer-implemented method of claim 9, further comprising:
pre-populating, based on contents of the personal profile information, one or more fields of the requested application;
wherein causing the information indicative the requested application to be transmitted to the client device comprises:
transmitting to the client device information indicative of the requested application with the one or more pre-populated fields.

11. The computer-implemented method of claim 10, further comprising:
receiving information specifying that the financial service provider approves the application for the financial product of the financial service provider;
transmitting, to the client device, information indicative of the approval; and
receiving, from the client device, instructions to update the personal profile information of the consumer with product detail information for the financial product for which the application is approved.

12. The computer-implemented method of claim 1, further comprising:
receiving, from a client device associated with the consumer, a request for an application for the identified financial product, with the identified financial product being included in the financial product recommendation specifically for the consumer;
causing information indicative of the requested application to be transmitted to the client device;
receiving, from the client device, a completed version of the requested application;
granting access to the completed version of the requested application to a financial service provider that provides a financial product that is applied for by the application; and
notifying the financial service provider that the completed version of the requested application is available for review.

13. The computer-implemented method of claim 1, further comprising:
receiving, from a client device associated with the consumer, a request for a price quotation for one or more financial products;
causing processing of the request for the price quotation by multiple providers; and
transmitting, to the client device, information indicative of multiple price quotes for financial products of the multiple providers.

14. The computer-implemented method of claim 13, wherein causing the processing comprises:
transmitting to the multiple providers anonymous information that is indicative of a request for a price quote, with the anonymous information not including identifying information of the consumer, and with the anonymous information including other types of information that promote generation of the price quote.

15. The computer-implemented method of claim 1, further comprising:
in response to the request, providing single-source application anonymous processing for multiple providers by:
accessing, from a data repository, personal profile information of the consumer;
generating anonymous consumer information by removing, from the personal profile information, identifying information of the consumer; and
transmitting to the providers the anonymous information for application processing.

16. The computer-implemented method of claim 1, further comprising:
generating information for a web-accessible provider portal that when presented on a client device displays:
a plurality of controls for a financial product service provider to view an application for a financial product, provide a quote for the financial product, and approve the application for the financial product.

17. The computer-implemented method of claim 1, further comprising:
analyzing consumer information stored in a customer profile database;
identifying, based on analyzing, common characteristics of consumers;
identifying, based on the common characteristics, a common product need of the consumers; and
generating a custom financial product for the consumers that address the common product need.

18. A computer-implemented method comprising:
retrieving information indicative of one or more financial products and providers;
applying one or more curation policies to the retrieved information, wherein a curation policy includes a criteria for a financial product or provider to satisfy for inclusion of a group of financial products to be scored;
filtering, based on applying the one or more curation policies, the financial products to a subset, with financial products in the subset satisfying criteria specified by the one or more curation policies.

19. One or more machine-readable hardware storage devices storing instructions that are executable by one or more processing devices to perform operations comprising:
comparing personal profile information of a consumer to financial product information for financial products;
identifying, based on the comparing, one of the financial products with a higher relevance to the consumer relative to relevances of others of the financial products; and
generating, based on the identified financial product, a financial product recommendation specifically for the consumer.

20. An electronic system comprising:
one or more processing devices; and
one or more machine-readable hardware storage devices storing instructions that are executable by the one or more processing devices to perform operations comprising:
comparing personal profile information of a consumer to financial product information for financial products;
identifying, based on the comparing, one of the financial products with a higher relevance to the consumer relative to relevances of others of the financial products; and
generating, based on the identified financial product, a financial product recommendation specifically for the consumer.
